(19) United States
(12) Patent Application Publication
(10) Pub. No.: US 2015/0363563 A1
(43) Pub. Date: Dec. 17, 2015

(54) METHODS AND SYSTEMS FOR AUTOMATED DEPLOYMENT OF REMOTE MEASUREMENT, PATIENT MONITORING, AND HOME CARE AND MULTI-MEDIA COLLABORATION SERVICES IN HEALTH CARE AND TELEMEDICINE

(71) Applicant: SnappSkin Inc., Chagrin Falls, OH (US)

(72) Inventor: Joachim H. Hallwachs, Chagrin Falls, OH (US)

(21) Appl. No.: 14/739,435

(22) Filed: Jun. 15, 2015

Related U.S. Application Data
(60) Provisional application No. 62/012,032, filed on Jun. 13, 2014.

(51) Int. Cl. G06F 19/00; H04L 29/08; H04B 5/00

(52) U.S. Cl. CPC G06F 19/3418; H04B 5/0062; H04L 67/06; G06F 19/322

(57) ABSTRACT

Various exemplary methods and systems for automated deployment of remote measurement, patient monitoring, and home care and multi-media collaboration services in health care and telemedicine are provided. In general, a system can allow automated deployment and simplified installation by non-technical personnel of sensor-based remote monitoring and process automation solutions.

### CROSS REFERENCE

The present application claims priority to U.S. Provisional App. No. 62/012,032 entitled “Automated Deployment and Operation of Remote Measurement and Process Control Solutions” filed Jun. 13, 2014, which is hereby incorporated by reference in its entirety.

### FIELD

The present disclosure relates generally to methods and systems for automated deployment of remote measurement, patient monitoring, and home care and multi-media collaboration services in health care and telemedicine.

### BACKGROUND

The next wave of evolution in the wireless industry, often termed “Internet of Things,” or “IoT,” refers to the wireless attachment of machine-controlled, low-cost sensor solutions for the purpose of local data capture and upload to a centralized, automated data analysis and processing function. The impact of the IoT paradigm in the context of specific vertical markets is the creation of dramatically improved process and state awareness, coupled with the means to implement centralized, automated monitoring and also human control functions. The IoT paradigm has the potential to dramatically lower cost, while improving the efficiency, of business processes and will also create new vertical automation and service delivery processes for new revenue opportunities.

Such wireless sensor based remote monitoring solutions include data network infrastructure and local network connectivity layers that can wirelessly attach embedded sensor solutions. Typically, sensors are purpose-built for specific vertical industry frameworks, e.g., heart rate sensors used in health care, or industrial system monitoring and process sensors for automation solutions.

The underlying complexity of network infrastructure and related deployment and configuration processes, as well as the associated recurring operational aspects all present major issues, stifling progress regarding the creation and adoption of remote sensor monitoring applications across many vertical industries, beginning with the local installation of the sensor connectivity layer. In essence, deployment complexity creates a direct dependency on network service providers, in turn coupling cost, network availability and quality, and installation related limitations inherent to any network access service—with the operation of the vertical industry solution. This dependency creates a systematic cost barrier and limiting factor to any scalable and flexible deployment of vertical IoT solutions.

In aggregate, implementation and initial deployment of a given IoT sensor solution itself cannot be realized in an automated fashion today. It cannot be realized as an embedded function of vertical industry processes and thus cannot be operated by staff with industry resident experience.

Accordingly, there remains a need for improved automated methods and systems.

### SUMMARY

In general, methods and systems for automated deployment of remote measurement, patient monitoring, and home care and multi-media collaboration services in health care and telemedicine are provided.

In one aspect, a method of managing health care is provided that in one example includes receiving at a central server sensor data from a first client terminal having a first application installed thereon. The sensor data is indicative of information gathered by at least one sensor regarding at least one parameter related to at least one of a health and wellness of a patient. The first application is configured to facilitate gathering of the information and transmission of the gathered information in real time with the gathering of the information. The sensor data received at the central server is anonymous so as to not be associated with protected health information (PHI) identifying the patient. The method also includes causing the received sensor data to be transmitted in real time from the central server to a second client terminal having a second application installed thereon. The second application is configured to facilitate receipt of the data from the central server and display of the data on the second client terminal in real time with the receipt of the sensor data at the second client terminal.

The method can vary in any number of ways. For example, the method can include analyzing the sensor data received at the central server in real time to determine if the received information indicates an alarm condition, and in response to determining that the alarm condition is indicated, causing an alert to be transmitted in real time to the second client terminal indicating occurrence of the alarm condition. For another example, the transmission to the second terminal can occur automatically in response to the receipt of the sensor data at the central server. For yet another example, the transmission to the second terminal can occur in response to a request received at the central server from the second client terminal requesting data gathered by the at least one sensor. For still another example, the method can include receiving an electronic order for a patient. The order can indicate the at least one parameter to be measured in real time with respect to the patient. The method can also include, in response to receiving the electronic order, causing the first application to be transmitted to a first client terminal, and causing the second application to be transmitted to the second client terminal. For another example, the method can include causing the sensor data received at the central server to be persistently stored in a storage device with stored sensor data not being associated with PHI information identifying the patient. For yet another example, the method can include causing at least one of an electronic medical record (EMR) and electronic health record (EHR) of the patient to be updated in response to the receipt of the sensor data at the central server. For still another example, the method can include receiving at the central server user input data from the second client terminal, and causing at least one of an EMR and EHR of the patient to be updated in response to the receipt of the user input data at the central server. The user input data can be input to the second client terminal by a user and can be related to the sensor data received at the second client terminal. For yet another example, at least one sensor can be in communication with the first client terminal, can be configured to measure the at least one parameter, and can be configured to transmit the measurements to the first client terminal. For still another example, the first application can be configured to facilitate display of the sensor on the first client terminal in real time with the gathering of the sensor data.

For another example, the method can include querying the first client terminal to determine a location of the at least one sensor. The location of the at least one sensor can be indicative of a location of the patient. The method can include querying a plurality of additional client terminals, each of the additional client terminals having associated therewith one or more sensors configured to gather information regarding at least one parameter related to at least one of health and wellness of one of a plurality of patients, to determine a location of each of the one or more sensors associated with the additional client terminals. The locations of the one or more sensors can be indicative of locations of the plurality of patients. The query can be performed either automatically in response to the first client terminal being in proximity of a location sensor, or on demand in response to a user request transmitted from the second client terminal to the central server.

For yet another example, the at least one parameter can include at least one of heart rate, blood pressure, temperature, weight, oxygen saturation (spO₂), electrocardiography (ECG), glucose, sleep, pulse, and motion. For another example, the first client terminal can be associated with the patient, and the second client terminal can be associated with a care provider of the patient.

In another aspect, a system is provided that in one example can include a cloud server that includes the central server. The central server can include a processor configured to execute the method. The system can have any number of variations.

In another embodiment, a method of managing health care is provided that includes gathering of patient data by a first application operating as an embedded function of a first client terminal. The data is indicative of information regarding at least one parameter related to health and wellness of a patient, and the gathered data is not persistently stored at the first client terminal. The method also includes transmitting the gathered patient data in real time from the first client terminal to a central server. The transmitted data is constructed as an anonymous patient data record so as to not be associated with protected health information (PHI) identifying the patient. The first application is configurable using a downloadable configuration template to facilitate the gathering of the patient data and the transmission of the gathered data in real time with the gathering of the data. The method also includes causing the received patient data record to be transmitted from the central server to a second application operating as an embedded function of a second client terminal. The second application is configured to request and receive a patient data record from the central server, and the second application is configured to cause display of at least a portion of the requested and received patient data record on a display of the second client terminal in real time with the receipt of the requested and received patient data record.

The method can vary in any number of ways. For example, the second client terminal can either be included as part of the first client terminal or can be a client terminal independent of the first client terminal. For another example, the received patient data record can be caused to be transmitted from the central server to the second application in real time with the receipt of the patient data record at the central server. For yet another example, the received patient data record can be caused to be transmitted from the central server to the second application in response to a user request.

For another example, the method can include determining a presence of the patient by one of scanning with the first application for a Bluetooth low energy (BLE) sensor device used as an identifying radio frequency identification (RFID) device to establish an identification of the patient, receiving a real time user input at the first client terminal, and receiving a parameterization input via the second application as part of a downloadable configuration template as part of a care path directive associated with the patient; causing the first application to confirm the presence and related identification of the patient with a cloud administration server, from which the first client terminal receives an anonymous and unique patient identification token used to record and identify the anonymous patient data record following the transmission of the gathered patient data to the central server; and causing the cloud administration server to transmit to the first application, with the patient identification token, one or more templates. The one or more templates can include the care path directive associated with the patient. The care path directive can specify time and method for the gathering of the patient data and including instructions regarding how to analyze and process data related to the patient and a care plan for the patient. The first application, under direction of the care path directive, can be configured to request other data related to the patient from at least one of the central server, from direct user input at the first client terminal, and a third party repository server, and the first application, under direction of the care path directive, can be configured to aggregate the gathered patient data and the other data with locally received sensor data from a plurality of sensors, as specified in the care path directive, to create an aggregated data record. The first application can be configured to combine the aggregated data record with the anonymous patient identification token and a time-stamp of each individual data capture to form an aggregated patient data record, and can be configured to then transmit the aggregated patient data record to the central server for persistent storage and at least one of post-processing and reporting. The method can include causing the aggregated patient data record received at the central server to be stored in a persistent and redundant storage device storing a plurality of aggregated patient data records each associated with a different anonymous patient identification token, thereby allowing subsequent authorized access to the stored aggregated patient data records, facilitating reporting functions, and facilitating post-processing with patient data or without associated PHI context. The method can include performing real-time analysis of the aggregated patient data record with the first application under direction of the care path directive to determine whether an alert condition is indicated, and, in response to determining that the alert condition is indicated, causing an alert to be transmitted in real-time to the cloud administration server for persistent alert storage, real-time alert distribution under direction of the care path directive, and subsequent alert administration and post-processing under direction of the care path directive. The second application can be configured to receive, in real-time and/or upon request, all open alerts related to a selected patient identification for display on the display of the second client terminal. The second application can be configured to receive the open alerts automatically and in real time in response to the receipt of the aggregated patient data record by the central server and the receipt of alerts by the central server. The transmission of the open alerts and the patient data record to the second application can occur in response to a request received from the second application at the central server requesting at least one of updated alerts and an updated patient data record. The request can be authorized by presenting the anonymous patient identification token in context of an authorized login by a care team member associated with the patient, using the second application. The authorization can be specified in the care path directive.

The first client terminal can be firmly associated with the patient, the first application can be embedded in the first client terminal using a configuration parameter downloaded as part of the care path directive, the first and second client terminals can be separate devices, the second application can be associated with a care provider of the patient at any physical location, and the first application, without direct input or control by the care provider, can be configured to automatically gather the patient data as specified in the care path directive through an automated process executed by the first application under direction of the care path directive including at least one of regular scanning for presence of any of the patient's associated wearable sensors and subsequent gathering of relevant data as specified in the care path directive.

The first client terminal can include the second client terminal such that the first application and the second applications are both embedded in the same terminal. The terminal can be associated with a care provider of the patient having secure account login access to the terminal using the second application. The terminal can be configured to dynamically determine an identity of the patient, subject to authorized access by the care provider, and can be configured to allow the care provider to select the identity as user input to the second application. The determined identity can be associated with the data gathered by the first application. The first application can be configured to detect physical presence of the patient through scanning for presence of at least one sensor associated with that patient, as specified in the care path directive.

For still another example, at least one sensor can be in communication with the first application, is configured to measure at least one parameter, and can be configured to transmit the measurements to the first application. For yet another example, at least one patient-wearable sensor can be in communication with the first application, the at least one patient-wearable sensor can be configured to gather the patient data, the at least one patient-wearable sensor can be configured as an active RFID sensor allowing identification of the patient at least one indirectly through a unique media access control (MAC) address thereof or directly through presentation of a system-unique patient identifier by the at least one patient-wearable sensor, and the method can include the first application determining presence of the patient using the identification of the patient, thus associating a location of the patient relative to a location of the first client terminal using an open standards-based wireless association method. The location of the first client terminal can be physical or logical. For another example, the method can include querying the first application to determine the presence of at least one active RFID sensor using an open standards-based wireless association method, with the presence of the active RFID sensor being indicative of the location of the patient near the first client terminal. For yet another example, the first client terminal can include a plurality of client terminals each having an instance of the first application embedded thereon, and the method can include querying the first applications in real time, thereby causing the plurality of client terminals to scan for its association with one or more active RFID sensors to determine a location of the one or more active RFID sensors relative to the associated one of the plurality of client terminals, with the location of the one or more active RFID sensors being indicative of the locations of a related plurality of patients at that time relative to a location of an associated one of the client terminals, thereby establishing an overall patient census and a location map relative to physical locations of the plurality of client terminals. The location of the associated client terminals can be physical or logical. For still another example, the method can include the first application performing a continuous or automatically scheduled query, thereby detecting at least one of a presence of the patient and a presence of multiple patients and location changes thereof. The query can be performed either automatically under direction of a care path directive, by an automated scheduled process executing on the server, or in response to a request transmitted from the central server to the first application triggered by a user input to the second application.

For another example, the method can include receiving an electronic order by the server for the patient, identified by a PHI record of the patient. The electronic order can provide at least a minimum amount of information required to identify one or more of a pre-established application template, a configuration template, a care team template, a device template, a care plan template, and a related medical protocol template, to identify at least one type of health, wellness, or safety data gathering request. The method can include, in response to receiving the electronic order, processing the patient's PHI information by the server for persistent storage and establishing by the server a unique patient identification token and a care path directive, based on all the received pre-established templates, for complete operation and execution of the electronic order, and, after assembling the executable care path directive, automatically processing by the server all operational elements in the executable care path directive that require to transmit, install, and launch applications with their associated one or more templates on client terminals that have been allocated as part of the care path directive.

For still another example, the method can include causing the central server to request an aggregated patient data record and to combine the requested aggregated patient data record with identifying PHI information for transmission of a secure data message using the HL7 protocol to an electronic medical record (EMR) system, on behalf of the patient. The aggregated patient data record can be requested in real time by an explicit electronic data request, in form of an HL7 message, received by the server from the EMR system. The combining can be triggered automatically as a periodic update as part of an electronic order, received as an HL7 message from the EMR system, and can have been scheduled by the central server as a function of a care path directive of the patient.

In another aspect, a cloud based system is provided including multiple sub-systems and including a central cloud administration server. The central cloud administration server can include a processor configured to execute at least some of the method. The system can have any number of variations. For example, the central cloud administration server can have access to the PHI, credentials and authorized data of registered users, electronic ordering records, software resources, device templates and registration records, and pre-defined and/or dynamic information required for creation of care path directives. The central cloud administration server can be configured to create the care path directives for all of a plurality of patients, and can be configured to execute centralized operation of the created care path directives in real-time, as instructed by at least one of parameters received in duly authorized external electronic orders, explicit input of duly authorized registered users using a secure web based graphical user interface GUI, and by explicit instruction through input on the second application operating under control of a duly authorized registered user.

In another embodiment, a cloud based system can include multiple sub-systems and can include a central collaboration server. The central collaboration server can include a processor configured to execute at least some of the method under direction of the central server in execution of patients' care path directives. The system can have any number of variations.

In another embodiment, a cloud based system can include multiple sub-systems and including a central data repository server. The central data repository server can include a processor configured to execute at least some of the method under control of the central server. The system can have any number of variations. For example, the central data repository server can be configured to execute persistent storage of anonymous patient data records, received from a plurality of client terminals including the first and second client terminals, in execution of patients' care path directives.

In another embodiment, a cloud based system can include multiple sub-systems and can include a central cloud administration server. The central cloud administration server can include a processor configured to receive and execute electronic ordering messages from authorized external business systems and configured to receive and execute user input commands received from authorized account holders using a secure web graphical user interface (GUI) to establish and control templates required for use in electronic orders as part of the method. The system can have any number of variations.

In another aspect, a system for managing health care is provided that in one example includes a cloud server, a first storage device, and a second storage device. The cloud server is configured to receive data indicative of measurements of at least one parameter with respect to a patient from a client terminal without the received data being explicitly associated with PHI identifying the patient. The at least one parameter is related to at least one of health and wellness of the patient. The first storage device is configured to electronically communicate with the cloud server. The cloud server is configured to cause the first storage device to store therein the data received by the cloud server without the stored data being associated with PHI identifying the patient. The second storage device is configured to electronically communicate with the cloud server. The cloud server is configured to cause the second storage device to store therein the data received by the cloud server with the stored data being associated with PHI identifying the patient. The cloud server is configured to distribute the received data to at least one additional client terminal without the distributed data being associated with PHI identifying the patient. The cloud server is configured to cause at least one of an EMR and EHR of the patient to be updated based on the received data.

The system can vary in any number of ways. For example, the system can include at least one sensor configured to measure the at least one parameter. The at least one sensor can be configured to transmit the measurements to the client terminal that then transmits the data to the cloud server. For another example, the cloud server can be configured to receive the data in real time with gathering thereof, the cloud sever can be configured to analyze the received data in real time with the receipt thereof to determine if the received data indicates an alarm condition, and in response to determining that the alarm condition is indicated, the cloud server can be configured to transmit an alert in real time with the determination of the alarm condition to at least one of the client terminal and one or more additional client terminals. The alert can indicate occurrence of the alarm condition. For yet another example, the at least one parameter can include at least one of heart rate, blood pressure, temperature, weight, oxygen saturation (spO₂), electrocardiography (ECG), glucose, sleep, pulse, and motion. For another example, the cloud server can be configured to cause the first storage device to store therein the data received by the cloud server with a secure, anonymous patient identification token that is generated by the cloud server from the PHI identifying the patient.

### BRIEF DESCRIPTION OF DRAWINGS

This invention will be more fully understood from the following detailed description taken in conjunction with the accompanying drawings, in which:

FIG. 1 is a schematic diagram of an embodiment of a network system;

FIG. 2 is a schematic diagram of an embodiment of a computer system;

FIG. 3 is a schematic diagram of an embodiment of an autonomous deployment architecture;

FIG. 4 is a schematic diagram of an embodiment of an autonomous deployment architecture having multi-sensor aggregation functionality;

FIG. 5 is a schematic diagram of an embodiment of an autonomous deployment architecture having sensor service aggregation and control functionality;

FIG. 6 is a schematic diagram of the autonomous deployment architecture of FIG. 5 including an embodiment of multi-sensor aggregation functionality;

FIG. 7 is a schematic diagram of the autonomous deployment architecture of FIG. 6 including an embodiment of embedded service automation and control functionality;

FIG. 8 is a schematic diagram of the autonomous deployment architecture of FIG. 7 including an embodiment of embedded multi-media service control functionality;

FIG. 9 is a schematic diagram of the autonomous deployment architecture of FIG. 8 including an embodiment of public switched telephone network redundancy and service operation functionality;

FIG. 10 is a schematic diagram of the autonomous deployment architecture of FIG. 8 including an embodiment of integrated multi-media communication and collaboration functionality;

FIG. 11 is a schematic diagram of the autonomous deployment architecture of FIG. 8 including an embodiment of process-integrated, flow-through service control functionality;

FIG. 12 is a schematic diagram of the autonomous deployment architecture of FIG. 8 including an embodiment of process-integrated sensor data flow control functionality;

FIG. 13 is a schematic diagram of the autonomous deployment architecture of FIG. 12 including an embodiment of flow-through policy provisioning functionality;

FIG. 14 is a schematic diagram of the autonomous deployment architecture of FIG. 13 including an embodiment of policy based service automation functionality;

FIG. 15 is a schematic diagram of an embodiment of a service policy template for the autonomous deployment architecture of FIG. 14;

FIG. 16 is a schematic diagram of another embodiment of a service policy template for the autonomous deployment architecture of FIG. 14;

FIG. 17 is a schematic diagram of an embodiment of an autonomous deployment architecture in a health care context;

FIG. 18 is a schematic diagram of the autonomous deployment architecture of FIG. 17 including an embodiment of prescriptive automation;

FIG. 19 is a schematic diagram of an embodiment of automated integrated telehealth collaboration service using the autonomous deployment architecture of FIG. 17 and the service policy template of FIG. 16;

FIG. 20 is a schematic diagram of another embodiment of an autonomous deployment architecture in a health care context;

FIG. 21 is a schematic diagram of yet another embodiment of an autonomous deployment architecture in a health care context;

FIG. 22 is a schematic diagram of an aspect of the autonomous deployment architecture of FIG. 21;

FIG. 23 is a schematic diagram of another embodiment of an autonomous deployment architecture in a health care context;

FIG. 24 is a schematic diagram of an aspect of the autonomous deployment architecture of FIG. 23;

FIG. 25 is an alternate schematic view of the aspect of the autonomous deployment architecture of FIG. 24;

FIG. 26 is an embodiment of a screen on a mobile phone displaying information related to the autonomous deployment architecture of FIG. 21;

FIG. 27 is an embodiment of a screen on a television displaying information related to the autonomous deployment architecture of FIG. 21; and

FIG. 28 is an embodiment of a screen on a desktop computer monitor displaying information related to the autonomous deployment architecture of FIG. 21.

### DETAILED DESCRIPTION

Certain exemplary embodiments will now be described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon.

Various exemplary methods and systems for automated deployment of remote measurement, patient monitoring, and home care and multi-media collaboration services in health care and telemedicine are provided. In general, a system can allow automated deployment and simplified installation by non-technical personnel of sensor-based remote monitoring and process automation solutions. One or more sensors, multiple types of sensors, and/or multiple control and service applications can be operated within the same remote location, which can facilitate the automated deployment and the simplified installation. In one example, the one or more sensors can include multiple sensors, which can help more data and/or different types of data to be collected and analyzed, thereby allowing more well-informed decisions to be made based on the data and/or allowing more accurate data to be gathered.

In at least some embodiments, the systems and methods provided herein allow an application (e.g., a control and service application) to be embedded on each of a plurality of client terminals. Each of the applications can be configured to facilitate sensor connection, data gathering, and communication channels. One or more sensors can be configured to be electronically connected to each of the embedded applications, which can then each scan for, associate with, and exchange data with the one or more sensors connected therewith. In an exemplary embodiment, the electronic connections can each be wireless, which can facilitate ease of use by eliminating the need for wired connection between the one or more sensors and the client terminals, and/or which can take advantage of wireless communication protocols (e.g., Bluetooth, etc.) built into a client terminal. The one or more sensors can be mobile. For example, any of the one or more sensors can include wearable sensors (e.g., a sensor attached to a belt, a sensor attached to a wristwatch, a sensor attached to a necklace, a sensor attached to a bracelet, etc.) configured to move when the user wearing the sensor move. Thus, the sensor can be configured to be local to the patient regardless of travel or other movement of the user between locations, which can help ensure sensor data gathering regardless of patient location, and/or the sensor can be configured to be detected by different client terminals as the sensor moves within ranges of each of the different client terminals, which can help allow data to be communicated when the user is within range of any of a plurality of client terminals having the application embedded thereon.

In at least some embodiments, the systems and methods provided herein can be provided in a health care context. In a health care context, more well-informed decisions regarding patient care (e.g., treatment plan progress, healing progress, prescription medication decisions, recommended physical therapy activities, diet instructions, etc.) can be made for a patient the more data and/or the more varied types of data are collected regarding the patient. In other words, patient care can be improved by using a greater number of sensors and/or by gathering different types of data (e.g., by monitoring different physiological parameters) with sensors. For another example, in a health care context, it can be difficult for medical professionals to receive accurate health-related and/or wellness-related information from patients due to any or more factors, such as the patient misremembering or forgetting to mention relevant information (occurrences of problems, transient symptoms, onset time of symptoms, duration of pain, timing of exercise, etc.) to a care provider in person, particularly in the case of elderly patients and in very young patients. In some instances, patients may not recognize health-related events (e.g., shortness of breath, change in blood pressure, change in pulse for a length of time, snoring, etc.) and/or wellness-related events at all or may not recognize health-related events and/or wellness-related events as being notable enough to mention to their care provider when such events would help the patient's care provider have a more complete picture of the patient's health and/or wellness and thus be better equipped to make decisions and best care for the patient. A patient's health as referred to herein generally refers to the patient's medical state (physical or mental) and is generally directed to treating illness and injury. A patient's wellness as referred to herein generally refers to the patient's physical, mental, and social well-being, including the patient's general overall safety, and is generally directed to preventing illness and injury. Gathering data using one or more sensors of the same or different types can help avoid these issues by allowing the sensors to gather date-stamped and time-stamped data regarding the patient. The care provider can therefore be better able to treat the patient because the care provider can have a more complete and accurate picture of the patient's condition and/or because the care provider can receive sensor-gathered data even when the patient is remotely located from the care provider (e.g., by receiving information over a network). The sensor data can be communicated in real time to the care provider, which can further facilitate care of the patient since conditions of concern can be identified and addressed quickly and/or the care provider need not rely on patient-relayed information to learn about health-related and/or wellness-related conditions, which in at least some cases may not even be possible based on the severity of the patient's temporary condition or chronic condition.

In at least some embodiments, the health care context can include providing the systems and methods described herein for skilled nursing operations, e.g., in skilled nursing facilities (SNF). The embedded applications can be provided to care team members at SNFs, which can help the care team members collaborate electronically (e.g., video chat, email, etc. using embedded applications) and/or can help SNFs have access to telehealth information, which is traditionally restrictive in SNFs due to traditional cost models associated with SNFs, which typically have very small budgets and electronic infrastructure as compared to hospitals.

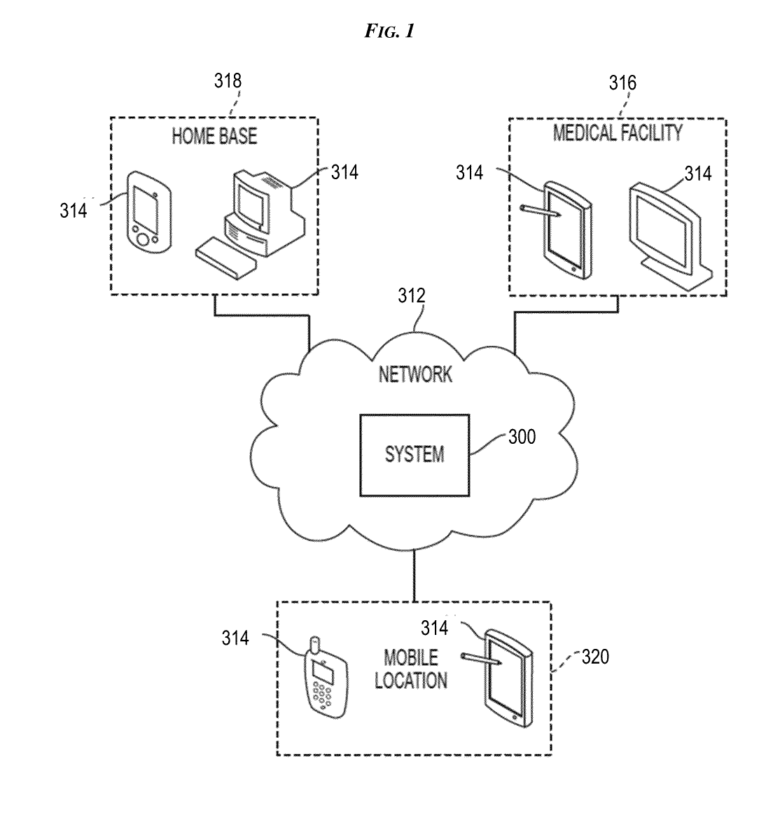

Users can interact with aspects of the systems and methods provided herein via a user interface. Any of a variety of users can access, interact with, control, etc. a user interface from any of a variety of locations. For example, as illustrated in FIG. 1, the user interface can be accessible over a network 312 (e.g., over the Internet via cloud computing) from any number of client stations (also referred to herein as “client terminals”) 314 in any number of locations such as a medical facility 316 (e.g., a hospital, a clinic, etc.), a home base 318 (e.g., a patient's home, a patient's office, etc.), a mobile location 320, and so forth. The client station(s) 314 can access the system 300 through a wired and/or wireless connection to the network 312. In an exemplary implementation, at least some of the client terminal(s) 314 can access the system 300 wirelessly, e.g., through Wi-Fi connection(s), which can facilitate accessibility of the system 300 from almost any location in the world. As shown in FIG. 1, the medical facility 316 includes client stations 314 in the form of a tablet and a computer touch screen, the home base 318 includes client stations 314 in the form of a mobile phone having a touch screen and a desktop computer, and the mobile location 320 includes client stations 314 in the form of a tablet and a mobile phone, but the medical facility 316, the home base 318, and the mobile location 320 can include any number and any type of client stations. In an exemplary implementation, the system 300 can be accessible by a client terminal via a web address and/or a client application (generally referred to as an “app”).

The system 300 can include security features. The security features can include data encryption using any of a variety of security protocols, e.g., HTTPS (HTTP secure), etc., and/or can include user authentication. User authentication can allow aspects of the system 300 to be available to a particular user based on the identity of the user and/or the location from which the user is accessing the system. To that end, each user can have a unique username, password, and/or other security credentials to facilitate access to the system 300. The received security parameter information can be checked against a database of authorized users to determine whether the user is authorized and to what extent the user is permitted to interact with the system, view information stored in the system, and so forth. Exemplary examples of parties who can be permitted to access the system 300 include patients, potential patients, significant others of patients or potential patients, friends of patients or potential patients, family members of patients or potential patients, doctors, nurses, medical assistants, insurers, home care staff, and hospital administrators.

The systems and methods disclosed herein can be implemented using one or more computer systems, also referred to as digital data processing systems and programmable systems. In general, a client terminal can include a computer system configured to facilitate data communication and data analysis.

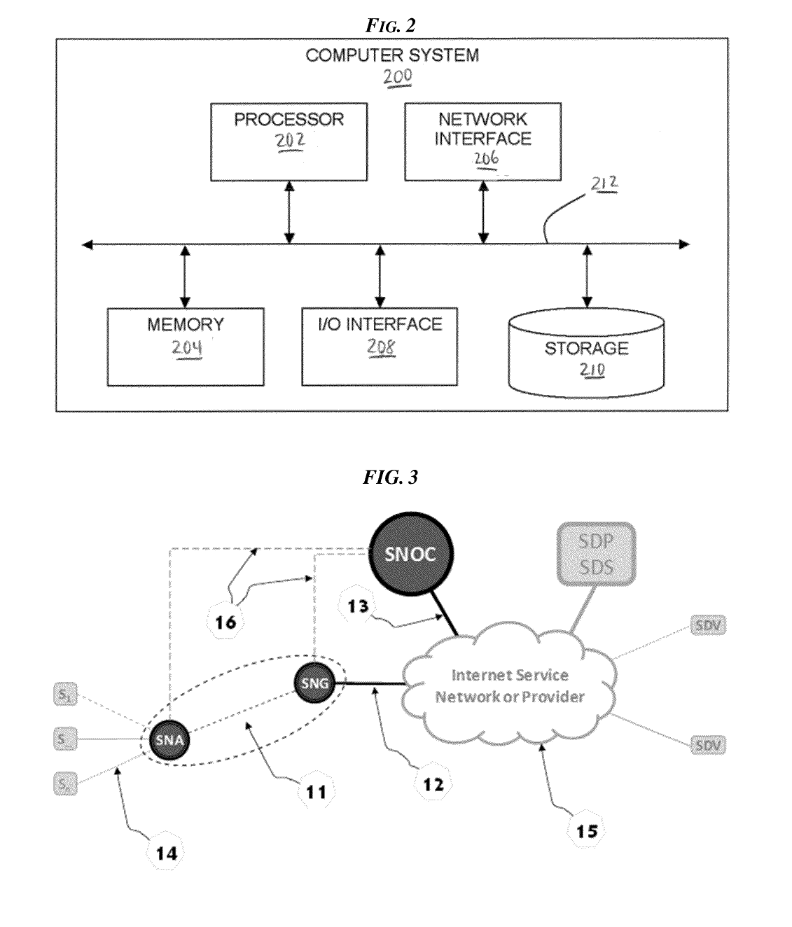

FIG. 2 illustrates one exemplary computer system 200. As shown, the computer system 200 can include one or more processors 202 which can control the operation of the computer system 200. The processor(s) 202 can include any type of microprocessor or central processing unit (CPU), including programmable general-purpose or special-purpose microprocessors and/or any one of a variety of proprietary or commercially available single or multi-processor systems. The computer system 200 can also include one or more memories 204, which can provide temporary storage for code to be executed by the processor(s) 202 or for data acquired from one or more users, storage devices, and/or databases. The memory 204 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

The various elements of the computer system 200 can be coupled to a bus system 212. The illustrated bus system 212 is an abstraction that represents any one or more separate physical busses, communication lines/interfaces, and/or multi-drop or point-to-point connections, connected by appropriate bridges, adapters, and/or controllers. The computer system 200 can also include one or more network interface(s) 206, one or more input/output (TO) interface(s) 208, and one or more storage device(s) 210.

The network interface(s) 206 can enable the computer system 200 to communicate with remote devices, e.g., other computer systems, over a network, and can be, for example, remote desktop connection interfaces, Ethernet adapters, and/or other local area network (LAN) adapters. The IO interface(s) 208 can include one or more interface components to connect the computer system 200 with other electronic equipment. For example, the IO interface(s) 208 can include high speed data ports, such as universal serial bus (USB) ports, 1394 ports, Wi-Fi, Bluetooth (BT), low-energy Bluetooth (BLE), etc. Additionally, the computer system 200 can be accessible to a human user, and thus the IO interface(s) 208 can include displays, speakers, keyboards, pointing devices, and/or various other video, audio, or alphanumeric interfaces. The storage device(s) 210 (also referred to as memories) can include any conventional medium for storing data in a non-volatile and/or non-transient manner. The storage device(s) 210 can thus hold data and/or instructions in a persistent state, i.e., the value is retained despite interruption of power to the computer system 200. The storage device(s) 210 can include one or more hard disk drives, flash drives, USB drives, optical drives, various media cards, diskettes, compact discs, and/or any combination thereof and can be directly connected to the computer system 200 or remotely connected thereto, such as over a network. In an exemplary implementation, the storage device(s) can include a tangible or non-transitory computer readable medium configured to store data, e.g., a hard disk drive, a flash drive, a USB drive, an optical drive, a media card, a diskette, a compact disc, etc.

The elements illustrated in FIG. 2 can be some or all of the elements of a single physical machine. In addition, not all of the illustrated elements need to be located on or in the same physical machine. Exemplary computer systems include conventional desktop computers, workstations, minicomputers, laptop computers, tablet computers, phablets, personal digital assistants (PDAs), mobile phones, smart wrist watches, and the like.

The computer system 200 can include a web browser for retrieving web pages or other markup language streams, presenting those pages and/or streams (visually, aurally, or otherwise), executing scripts, controls and other code on those pages/streams, accepting user input with respect to those pages/streams (e.g., for purposes of completing input fields), issuing Hypertext Transfer Protocol (HTTP) requests with respect to those pages/streams or otherwise (e.g., for submitting to a server information from the completed input fields), and so forth. The web pages or other markup language can be in Hypertext Markup Language (HTML) or other conventional forms, including embedded Extensible Markup Language (XML), scripts, controls, and so forth. The computer system 200 can also include a web server for generating and/or delivering the web pages to client computer systems.

In one example, the computer system 200 can be provided as a single unit, e.g., as a single server, as a single tower, contained within a single housing, etc. The systems and methods disclosed herein can thus be provided as a singular unit configured to provide the various modules, display the various user interfaces, and capture the data described herein. The singular unit can be modular such that various aspects thereof can be swapped in and out as needed for, e.g., upgrade, replacement, maintenance, etc., without interrupting functionality of any other aspects of the system. The singular unit can thus also be scalable with the ability to be added to as additional modules and/or additional functionality of existing modules are desired and/or improved upon.

While some exemplary implementations are described herein in the context of web pages, it will be appreciated that in other examples, one or more of the described functions can be performed without the use of web pages and/or by other than web browser software. A computer system can also include any of a variety of other software and/or hardware components, including by way of example, operating systems and database management systems. Although an exemplary computer system is depicted and described herein, it will be appreciated that this is for sake of generality and convenience. In other examples, the computer system may differ in architecture and operation from that shown and described here.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

The computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD), or a light emitting diode (LED) monitor for displaying information to the user and a keyboard and a pointing device, e.g., a mouse, a trackball, etc., by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

FIG. 3 illustrates an example of an autonomous deployment architecture in which data network functionality and local sensor connectivity and embedded control functions are logically entirely decoupled in implementation, installation, and operation. The autonomous deployment architecture fundamentally enables vertical enterprises to autonomously design, implement, deploy, and control industry-specific remote measurement and process control solutions and services. One example of such an industry is the health care industry. For example, an autonomous deployment architecture in accordance with FIG. 1 can allow for remote monitoring of patients and care provider control of the patient's care using the remotely monitored information.

As illustrated, the autonomous deployment architecture can include a local sensor network area 11 and a centralized Sensor Network Operation Center (also referred to as “SNOC” and “central operation center”). The local sensor network area 11 can include two sub-functions: a Sensor Network Gateway (also referred to as “SNG” and “gateway”) and a Sensor Network Appliance (also referred to as “SNA” and “appliance”). The SNOC, the SNG, and the SNA can each include a computer system, which in an exemplary implementation for each can include at least a processor, a memory (temporary storage and/or persistent storage), and a network interface. The SNG can include a logical network function that can be an embedded function of the SNA, forming a single unit for deployment. All sensor network functions can be connected to any external component via open and global standards based connectivity, e.g., a first communication line 12 connecting the SNG and a network 15, a second communication line 13 connecting the SNOC and the network 15 (e.g., an Internet service network or provider, a local area network, etc.), and a third communication line 14 connecting a plurality of sensors S₁, . . . Sₙ to the local sensor network area 11, where “n” equals two or more. The SNA and the SNG can each be connected to the centralized SNOC via a fourth communication line 16. Each of the communication lines 12, 13, 14, 16 can be any combination or wired or wireless and can each include one or more individual communication lines. In an exemplary implementation, the centralized SNOC can be hosted in a highly secure data center location and can be connected to the network 15 via the second communication line 13 as a high-speed connection.

The sensors S₁, . . . Sₙ can each be the same type as or a different type from any of the other sensors S₁, . . . Sₙ. Examples of the sensors S₁, . . . Sₙ include heart rate sensors, blood pressure sensors, thermometers and other temperature sensors, scales and other weight sensors, oxygen saturation (spO₂) sensors, electrocardiography (ECG) sensors, glucose monitors, sleep monitors, pulse monitors, motion sensors, accelerometers, cameras, and audio sensors. In an exemplary implementation, each of the sensors S₁, . . . Sₙ can be located in the same remote location (e.g., same location remote from the SNOC, such as in a same room, a same house, etc.) and can each be associated with a same target (e.g., with a single patient).

An autonomous deployment architecture can include a plurality of sensor groups, with each of the groups including a plurality of sensors at a same remote location and each of the groups being in communication with its own SNA, e.g., with a dedicated SNA. In other words, the autonomous deployment architecture can have multi-sensor aggregation functionality.

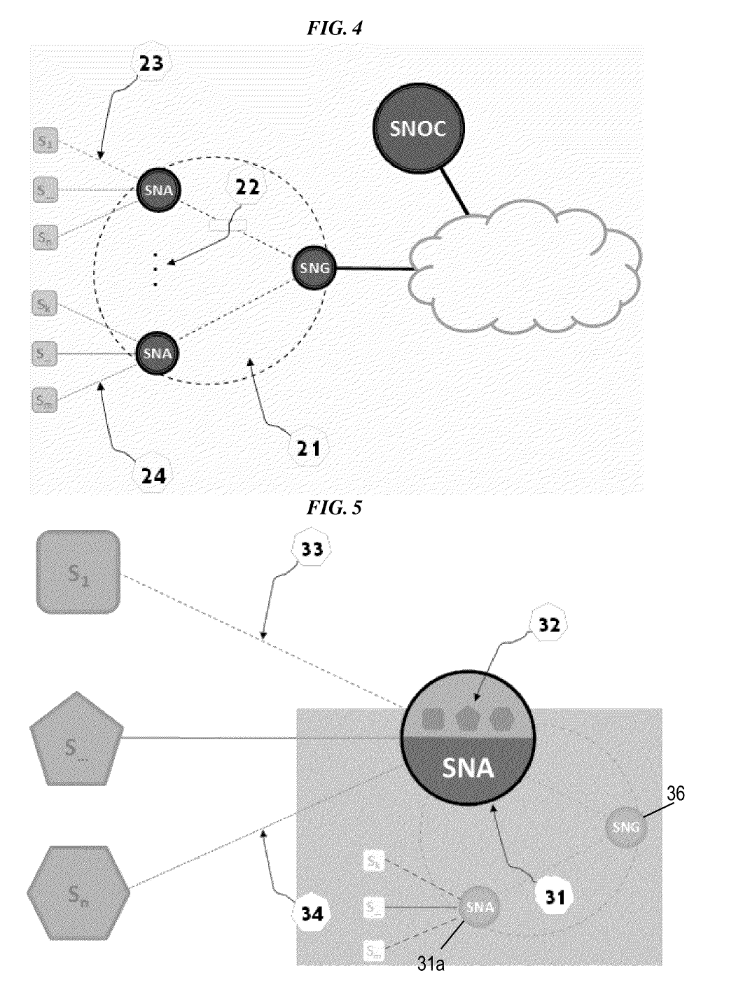

FIG. 4 illustrates an example of an autonomous deployment architecture having multi-sensor aggregation functionality. As illustrated, a first sensor group including sensors S₁, . . . Sₙ, where “n” equals two or more, can be in communication with a first SNA of a local sensor network area 21 along a first group communication line 23 and a second sensor group including sensors Sₖ, . . . Sₘ, where “k” equals one and “m” equals two or more, can be in communication with a second SNA of the local sensor network area 21 along a second group communication line 24. The first and second sensor groups can, however, all communicate with the same SNA and/or can be configured to switch between communicating with different SNAs in the local sensor network area 21. Such flexibility of SNA communication can promote efficient use of system resources.

In one example, the sensor groups can be remotely located from a SNOC and can be local to one another (e.g., in a same house, in a same office building, etc.) but not necessarily be at the same location as each other (e.g., are in different rooms of the same house, are in different rooms in a hospital ward, are in different cars on a same stretch of highway, etc.). The sensors groups can thus be located at various locations relevant to their use (e.g., heart rate sensors and blood pressure sensors near exercise equipment, motion sensors in physical therapy rooms, breathing rate sensors in bedrooms, etc.) such that the user associated with the sensor groups need not transport the sensors S₁, . . . Sₙ; Sₖ, . . . Sₘ between locations, which can be particularly helpful for users with limited mobility, limited strength, reduced memory, etc., such as the elderly, having the sensor groups at their place of residence.

Whether an autonomous deployment architecture includes a single sensor group including a plurality of sensors or a plurality of sensor groups each including a plurality of sensors, any of the sensors in the autonomous deployment architecture can be different (e.g., by being configured to measure a different parameter or by being manufactured by a different vendor) from any one or more of the other sensors in the autonomous deployment architecture. In other words, the autonomous deployment architecture can have sensor service aggregation and control functionality. The sensors can thus be selected to suit a particular user with which the sensors are associated. In a health care context, the sensors can be chosen for a particular patient so as to measure the parameters relevant to that particular patient's condition, appropriate for that patient's level of ability (e.g., less complicated sensors for older patients and for younger patients, etc.) and/or to reflect costs relevant to the patient (e.g., insurance coverage, out of pocket costs, etc.).

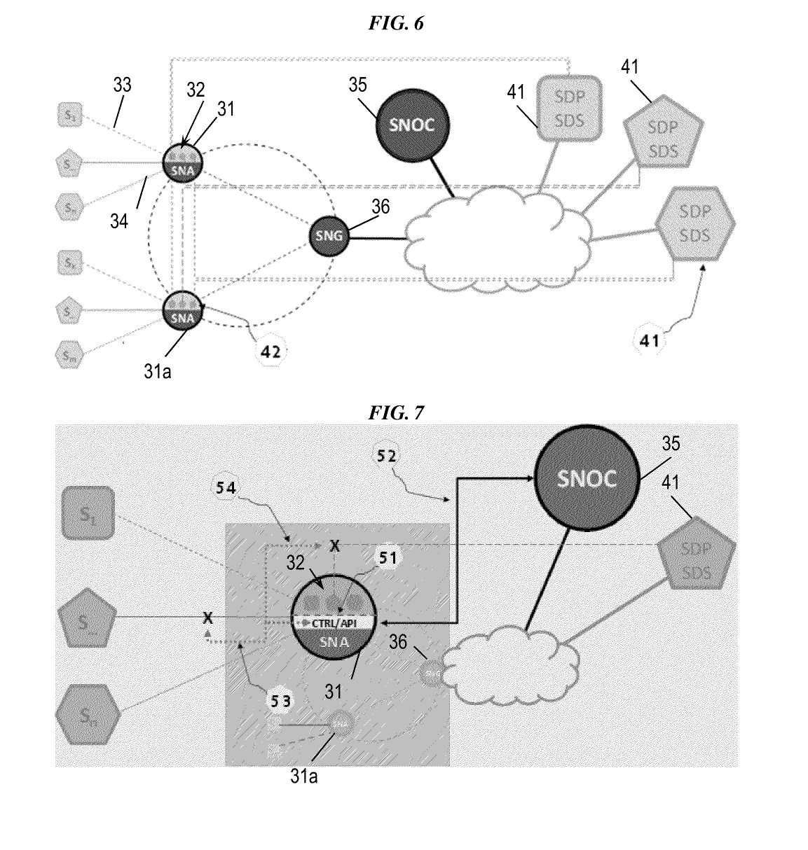

FIG. 5 illustrates an example of an autonomous deployment architecture having sensor service aggregation and control functionality. As illustrated, each of a plurality of sensors S₁, . . . Sₙ, where “n” equals two or more, can be different from one another. Each of the sensors S₁, . . . Sₙ can be configured to communicate with an SNA 31 over a communication line 33, 34 associated therewith, as also shown in FIG. 6. The SNA 31 can have a plurality of sensor and service apps 32 installed thereon, e.g., embedded therein, with each of the apps 32 being associated with a different one of the sensors S₁, . . . Sₙ. In this way, each of the sensors S₁, . . . Sₙ can be controlled via the SNA 31 according to their particular requirements, capabilities, etc. using the appropriate one of the apps 32 and/or can facilitate scalability by allowing sensors to be easily added to the system. For ease of illustration, each of the sensors S₁, . . . Sₙ shown in FIGS. 5 and 6 is represented by a polygon shape, with the one of the apps 32 associated therewith being represented by the same polygon shape.

In one example, each of the apps 32 can be automatically installed on the SNA 31 in response to the one of the sensors S₁, . . . Sₙ associated therewith being connected to the SNA 31, e.g., automatically downloaded to the SNA 31 from a SNOC 35 via an SNG 36 (see FIG. 6), which can improve user experience. This automatic functionality can be achieved by the embedded use of an operating system in the SNA sub-function, such as an operating system that offers automated application download and installation capability, such as any of a variety of presently available mobile device operating systems. Users thus need not log in to the SNOC 35, e.g., need not log in to the cloud, in order to receive or use the apps 32.

The sensors S₁, . . . Sₙ can be one sensor group of a plurality of sensor groups so as to be part of a system including multi-sensor aggregation functionality, as shown in FIG. 6, which includes a second sensor group illustrates Sₖ, . . . Sₘ, where “k” equals one and “m” equals two or more, in communication with a second SNA 31a. Similar to the SNA 31, the second SNA 31a can have a plurality of sensor and service apps 42 installed thereon, with each of the apps 42 being associated with a different one of the sensors Sₖ, . . . Sₘ, and with the second SNA 31a being configured to automatically download the apps 42, as discussed herein. For ease of illustration, each of the sensors Sₖ, . . . Sₘ shown in FIG. 6 is represented by a polygon shape, with the one of the apps 42 associated therewith being represented by the same polygon shape.

Each of the sensors Sₖ, . . . Sₘ; S₁, . . . Sₙ can be configured to have its own independent control and data connectivity with respective sensor data software (SDS) and/or sensor data processing (SDP) sub-systems 41, as shown in FIG. 6. For ease of illustration, the sub-systems 41 are each represented in FIG. 6 by a polygon shape corresponding to the shape of the one or more of the sensors Sₖ, . . . Sₘ; S₁, . . . Sₙ with which they are associated.

An SNA can have an open application programming interface (API) and control layer embedded therein. The embedded open API and control layer can interact with any sensor and service apps embedded in the SNA and can securely connect to a SNOC. The autonomous deployment architecture can thus have embedded service automation and control functionality.

FIG. 7 illustrates an example of an autonomous deployment architecture having embedded service automation and control functionality. For ease of explanation, the system of FIG. 7 uses the system of FIG. 6 by way of example and shows the sensors S₁, . . . Sₙ; Sₖ, . . . Sₘ, the SNAs 31, 31a, the apps 32 embedded in the SNA 31, the SNOC 35, the SNG 36, and the SDP and SDS sub-systems 41 of FIG. 5 and/or FIG. 6 (only one of the SDP and SDS sub-systems 41 is shown in FIG. 7). The SNA 31, as illustrated, includes an embedded open API and control layer 51. The open API and control layer 51 can be configured to control the operational framework of the sensor and service control apps 32 installed on the SNA 31 to control individual electronic attachments 53 (e.g., communication lines) of the sensors S₁, . . . Sₙ to the SNA 31, and to control message data flow 54 (e.g., communication over communication lines) between the sensor and service control apps 32 and their related SDS and SDP sub-systems 41. The embedded open API and control layer 51 can be configured to be automatically controlled by the SNOC 35 via a communication line 52, which can facilitate centralized service automation. In an exemplary implementation, the communication line 52 can use highly secure and encrypted transport and messaging technology. The second SNA 31a associated with the second sensor group can similarly include an embedded open API and control layer.

An open API and control layer installed on an SNA can be configured to facilitate process and service automation methods that use open and standards based communication, collaboration, and alerting interfaces connected to the SNA. Such functionality is referred to herein as embedded multi-media service control.

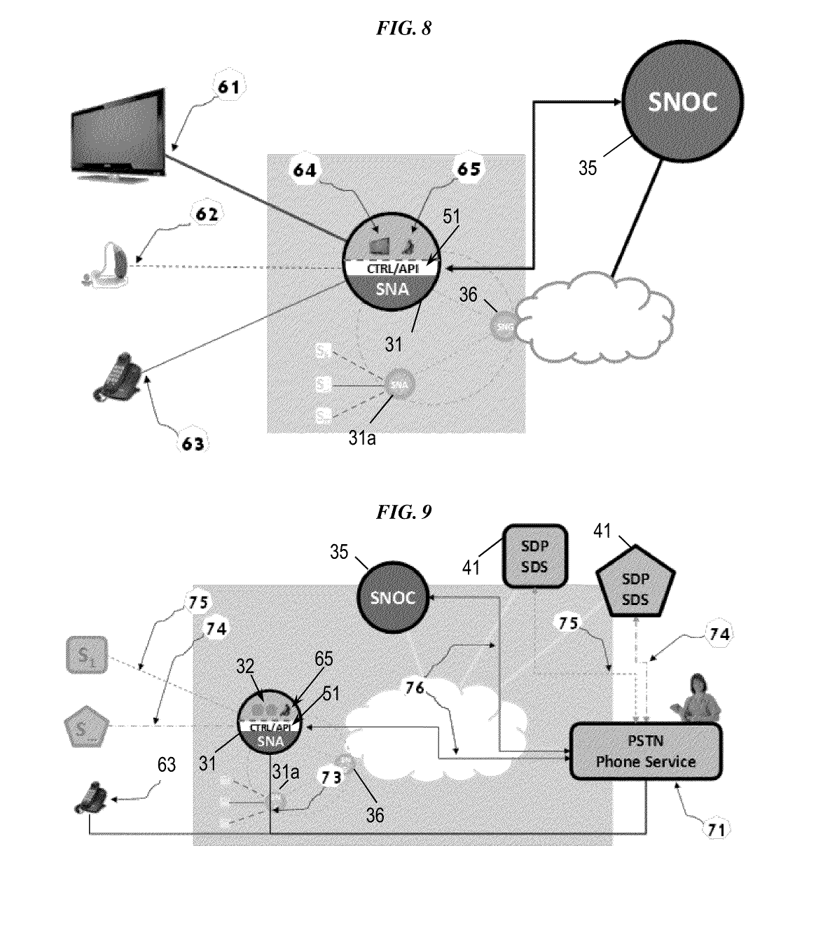

FIG. 8 illustrates an example of an autonomous deployment architecture having embedded multi-media service control functionality. For ease of explanation, the system of FIG. 8 uses the system of FIG. 7 by way of example and shows the sensors Sₖ, . . . Sₘ, the SNAs 31, 31a, the API and control layer 51 embedded in the SNA 31, the SNOC 35, and the SNG 36. As illustrated, the SNA 31 can be configured to electronically connect via one or more communication lines to one or more multi-media devices, which generally include devices having at least one multi-media function (e.g., audio, video, etc.), such as televisions (e.g., Internet Protocol televisions (IPTVs)), computer system displays, mobile phones, etc., and configured to communicate over a network.

In an exemplary implementation, similar to that discussed above regarding the sensor groups, the one or more multi-media devices can be remotely located from a SNOC and can be local to one another (e.g., in a same house, in a same office building, etc.) but not necessarily be at the same location as each other (e.g., are in different rooms of the same house, are in different rooms in a hospital ward, are in different cars on a same stretch of highway, etc.). The one or more multi-media devices can thus be located at various locations relevant to their use (e.g., computer monitor in a home office, hearing aid with its user, etc.). Additionally, the one or more multi-media devices can be local to the sensor(s) in electronic communication with the SNA to which the one or more multi-media devices are connected so as to form a comprehensive data gathering and data communication system.

In the implementation of FIG. 8, the multi-media devices include a television 61, a hearing aid 62 having wireless Bluetooth functionality, and a landline telephone 63. The SNA 31 can include one or more multi-media service control apps 64, 65 installed thereon, e.g., embedded therein, with each of the apps 64, 65 being associated with a different multi-media device connected thereto. Connectivity options, as well as the operating framework of multi-media service control apps 64, 65, can be controlled by the SNOC 35 via the SNA embedded API and control layer 51.

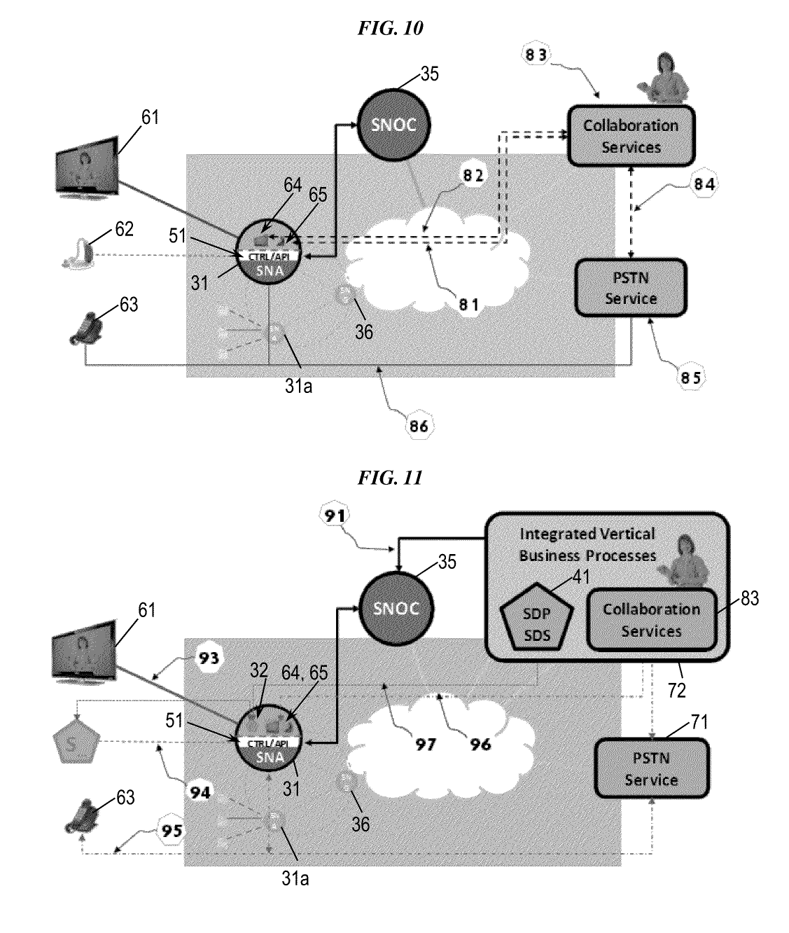

In the implementation of FIG. 8, a first multi-media service control app 64 is associated with the television 61, and a second multi-media service control app 65 is associated with the telephone 63. Video output capability of the television 61 can be configured to be handled by standard drivers in the operating system of the SNA 31. The first multi-media service control app 64 can be configured to use and control the television's video output capability, and video connection options and embedded drivers, as well as optional video applications, can be controlled by the SNOC 35 via the SNA's API and control layer 51. Telephony service of the telephone 63 can be configured to be handled by standard drivers in the operating system of the SNA 31. Alternatively, the telephone 63 can be connected to a private or enterprise telephony service line 86 configured to communicate with the second multi-media service control app 65 through open and global standards-based telecommunication protocols, as shown in FIG. 10. In both cases, the telephony service can be configured to be controlled by the SNOC 35 via the communication line 52 to the SNA embedded API and control layer 51.

The SNA 31 can be configured to control local audio equipment (e.g., Bluetooth-equipped audio devices, etc.), such as the Bluetooth-enabled hearing aid 62, using standard driver in the SNA's operating system. The audio service can be configured to be used and controlled by the multi-media service control apps 64, 65. Bluetooth audio connection options (and/or audio connections using protocols other than Bluetooth as appropriate for multi-media devices electronically connected to the SNA 31) and embedded drivers, as well as optional service applications, can be configured to be controlled by the SNOC 35 via the SNA embedded API and control layer 51.

Thus, similar to the sensor and service apps discussed herein, the multi-media service control apps 64, 65 can allow each of the multi-media devices 61, 62, 63 to be controlled via the SNA 31 according to their particular requirements, capabilities, etc. using the appropriate one of the apps 64 and/or can facilitate scalability by allowing multi-media devices to be easily added to the system. The second SNA 31a associated with the second sensor group can be similarly configured to electronically connect via one or more communication lines to one or more multi-media devices.

The system can be configured to employ embedded telephony interface and service control capability used for dial-up data connectivity and transport. Dial-up data service capability can be configured to be handled by standard drivers in the operating systems of the SNAs 31, 31a. This functionality is referred to herein as public switched telephone network (PSTN) redundancy and service operation functionality. Although various figures and implementations described herein show and/or are described with reference to a PSTN, a person skilled in the art will appreciate that a mobile service network (MSN) or other appropriate network can be used instead.

FIG. 9 illustrates an example of an autonomous deployment architecture having PSTN redundancy and service operation functionality. For ease of explanation, the system of FIG. 9 uses the system of FIG. 8 by way of example and shows the sensors S₁ . . . ; Sₖ, . . . Sₘ, the SNAs 31, 31a, the API and control layer 51 embedded in the SNA 31, the SNOC 35, the SNG 36, two of the sub-systems 41, and the telephone 63. As illustrated, the SNA 31 can be configured to connect to a traditional PSTN service network 71 and wired interface 73, e.g., in a shared configuration with an existing on-premise telephone 63. The SNA 31 can employ embedded open and global standard dial-up capability, such as V.92, to connect to the SNOC 35 through PSTN service network 76. PSTN dial-up data connectivity can serve as a reliable redundancy option for standard IP based service access (see, e.g., FIG. 3), or it can be a stand-alone operational mode when fixed or wireless broadband connectivity is not yet installed or is not available for installation at all. All attached connections to the SNA 31, their embedded drivers, as well as their respective service applications, can be configured to be controlled by the SNOC 35 via the SNA embedded API and control layer 51, optionally using redundant, low-speed dial-up data connectivity. The second SNA 31a associated with the second sensor group can be similarly configured to the SNA 31 as described with respect to FIG. 9.

FIG. 9 also illustrates the aggregation of two of the sensors S₁, . . . Sₙ in communication with the SNA 31 over respective dial-up communication lines 75, 74. Aggregated sensor data may not require high data transport capacity, so the depicted dial-up data connectivity via the communication lines 74, 75 can be sufficient. The dial-up connectivity and PSTN operation of FIG. 9 can be a standard deployment mode for such sensor network applications.

The collaborative functionality of the autonomous deployment architectures described herein is not limited to any particular telecommunication service provider or technology. The collaborative functionality can thus be implemented, but is not limited to operate, as a fully integrated function of vertical enterprise communication or multi-media collaboration services. This can allow seamless integration with collaborative enterprise and industry processes, which can be especially desirable when remote locations are end-user service delivery locations. This functionality is referred to herein as integrated multi-media communication and collaboration.

FIG. 10 illustrates an example of an autonomous deployment architecture having integrated multi-media communication and collaboration functionality. FIG. 10 uses the system of FIG. 8 by way of example. FIG. 10 illustrates the SNA embedded operation of the telephony and video apps 65, 64, integrated with respective centralized unified communication 81 and/or multi-media 82 collaboration services, e.g., enterprise collaboration services 83. Public or enterprise unified communication services can have standard interworking functions with a traditional phone service provider 85, which in turn can provide service to a traditional local phone line 86 serving the telephone 63. Thus, SNA embedded multi-media applications 64, 65 can be configured to control, originate and even automate telephone connections within the local sensor network area, also in cases where local telephone equipment is not directly connected to the SNA 31 as with the PSTEN 85. As illustrated, operation of unified communication and collaboration applications, as well as the connectivity to SNA attached devices, can be controlled by the SNOC 35 via the secure transport connection 52 to the SNA embedded API and control layer 51.

An autonomous deployment architecture can be configured to exchange control information, of any kind, between vertical enterprise business processes and a SNOC. The SNOC can be dedicated for a single enterprise or can be shared between a plurality of enterprises. This interface can combine vertical process integration with automated deployment and operation capability so as to enable process-integrated, flow-through service control functionality.

FIG. 11 illustrates an example of an autonomous deployment architecture having process-integrated, flow-through service control functionality. For ease of explanation, the system of FIG. 11 uses the system of FIG. 8 by way of example. FIG. 11 shows integration of the SNOC 35 with vertical business processes of an enterprise 72 via an information exchange interface 91, e.g., a communication line. The control function of the SNOC 35 can extend to the local sensor network area, e.g., to the first sensor group including the sensors S₁, . . . Sₙ, via the communication line 52 to the API and control layer 51 of the SNA 31 which can be configured to control interfaces electronically attached thereto via one or more multi-media communication lines 93, one or more sensor communication lines 94 (e.g., the communication lines 33, 34), and one or more telephony communication lines 95 and using the SNA-embedded apps 32, 64, 65. The SNA-embedded apps 32, 64, 65 can be in communication with the enterprise 72 via a communication line 97, which can create an end-to-end application paradigm for automated remote sensor network solutions and along communication lines 95, 96 for related embedded collaboration applications. This combination can provide cost-effective, automated local monitoring, collaboration, and process control using direct machine-to-machine data exchange while facilitating human information and decision flow. The SNOC 35 can thus be configured to facilitate implementation of the enterprise 72 using the various sensors and multi-media devices electronically connected to the SNOC 35 via the SNAs 31, 31a. For example, in a health care context, the SNOC 35 can be configured to facilitate implementation of enterprise 72 as related to a hospital, an insurer, and/or care provider care plans for each of a plurality of patients using sensors and multi-media devices associated with the individual patients and locally located relative to the patients and remotely located relative to the hospital, insurer, and/or care provider.

An autonomous deployment architecture can have open interface capability regarding the exchange of sensor network related data, e.g., actual sensor measurement results, locally processed measurement results and related alerts and collaboration messages, status information related to the sensor itself as it relates to the project (e.g., to the patient's care plan, etc.), etc. This functionality is referred to herein as process-integrated sensor data flow control functionality.

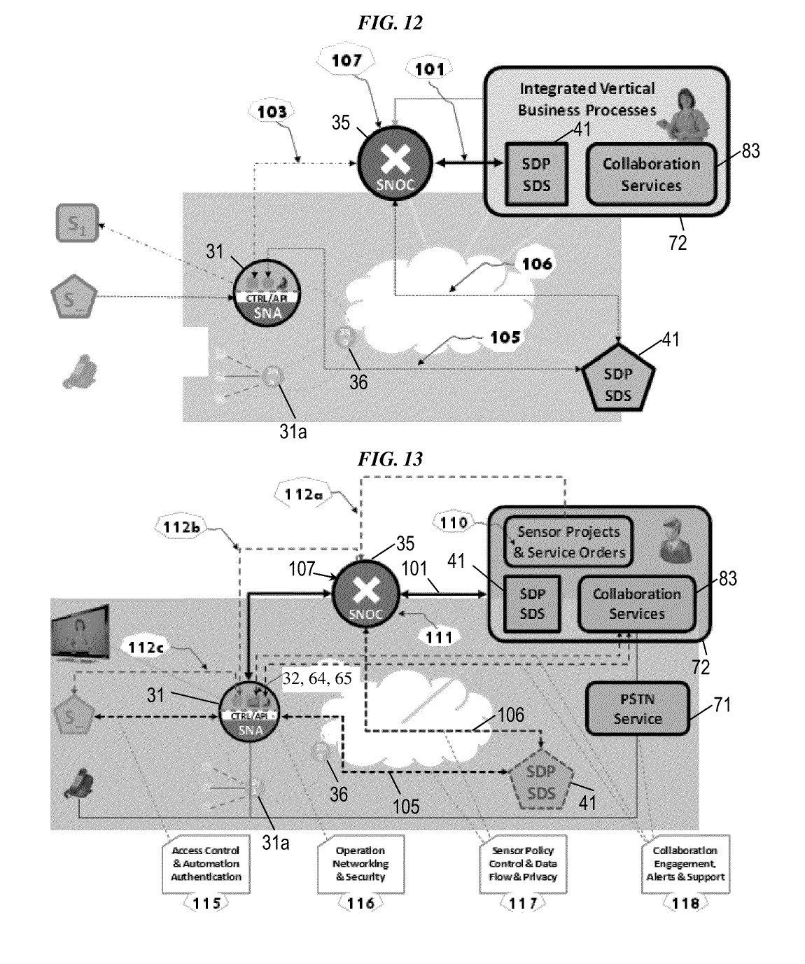

FIG. 12 illustrates an example of an autonomous deployment architecture having process-integrated sensor data flow control functionality. For ease of explanation, the system of FIG. 12 uses the system of FIG. 8 by way of example. As illustrated, an enterprise information exchange interface 101, e.g., a communication line, can span between the SNOC 35 and sensor data driven ones of the vertical business processes of the enterprise 72, e.g., SDS and SDP sub-systems 41. The SNOC 35 can be configured to implement a specific data and message exchange model between the SNOC 35 and the sensor data driven ones of the vertical business processes of the enterprise 72 to aggregate data from different sensor vendors, applications, and sensor project status data and alerts. A data and message exchange function 107 of the SNOC 35 can be configured to streamline SDS and SDP implementations for enterprises, importantly in compliance with vertical industry requirements, implicitly providing sensor vendors with compliant information exchange interface 101 capability. For example, in a health care context, the data and message exchange function 107 of the SNOC 35 can be configured to help enforce compliance with health care standards or regulations for sensors used to gather data regarding patients.

FIG. 12 shows that the SNOC 35 can be configured to provide the sensor and service control apps 32, 64, 65 installed on the SNA 31 with secure data and message transport via a communication line 103 to the SNOC data and Message Exchange Function 107 to transform and forward relevant and real-time status data and alert information on to the enterprise 72 via the information exchange interface 101. FIG. 12 also shows that the SNOC 35 can be configured to provide a data and message exchange capability to third party SDP systems of sensor vendors via a communication line 106, e.g., when raw sensor data from any of the sensors S₁, . . . Sₙ connected to the SNA 31 sent from the SNA 31 to the sensor cloud via a communication line 105 needs to be stored and/or pre-processed before the enterprise is able to integrate the information with its business processes. The SNOC data and message exchange function 107 can be configured to transform data from the external SDP function, received via the communication line 106, and forward the transformed information to the enterprise via the information exchange interface 101 in a manner compliant with vertical business requirements.

An autonomous deployment architecture can have a flow-through integration capability regarding the exchange of service operation and control data, also referred to as “service policies.” Service policies include information templates related to provisioning and operation of services. The templates can facilitate scalable, automated remote deployment, activation, and operation of services and can replace local human intervention. Service policies can contain information elements related to security and private collaboration overlays that allow the authentication of network access and communication services, e.g., that trigger an automated exchange of secure messaging and alerts regarding specific events and services. This functionality is referred to herein as flow-through policy provisioning functionality.

FIG. 13 illustrates an example of an autonomous deployment architecture having flow-through policy provisioning functionality. For ease of explanation, the system of FIG. 13 uses the system of FIG. 12 by way of example. As shown in FIG. 13, the information exchange interface 101 spanning between the data and message exchange function 107 of the SNOC 35 and the enterprise 72 can be configured to implement an industry compliant data and message exchange model between the SNOC 35 and the enterprise 72, which can allow exchange of service policies as related to vertical business processes 110. The embedded SNOC data and message exchange function 107 can be configured to transform and forward along a communication line 112a service policy messages from the vertical business processes 110 to the SNOC 35 for storage and archive, e.g., for storage in a cloud database 111 (e.g., a memory) of the SNOC 35. The SNOC 35 can be configured to relay received service policy/policies to the embedded API and control layer 51 of the SNA 31 along a communication line 112a and to embedded API and control layers of any other SNAs in communication with the SNOC 35, e.g., the SNA 31a. The API and control layers can be configured to store the received service policy/policies and to forward related information to the embedded sensor and service control apps 32, 64, 65 installed on the SNA 31 and to the apps embedded on the other SNA(s) which receive the information. The sensor and service control apps that receive the information can be configured to complete flow-through provisioning using the received service policy template information to manage attached devices and related services, e.g., manage attached sensor along a communication line 112c.

FIG. 13 illustrates examples of service policies related to operation of sensor based remote monitoring and related collaboration services, although other types of service policies can be used. In particular, as illustrated, the service policies can include an access control and automation authentication service policy 115 (received by one of the sensors S₁, . . . Sₙ in FIG. 13 and generally related to sensor access control), an operation networking and security service policy 116 (received by the API and control layer 51 in FIG. 13 and generally governing network and security operation), a sensor policy control, data flow, and privacy service policy 117 (received by the API and control layer 51 and the standalone SDP and SDS sub-system 41 in FIG. 13 and generally governing sensor data handling and privacy policies), and a collaboration engagement, alerts, and support service policy 118 (received by the multi-media apps 64, 65 and the PSTN service 71 in FIG. 13 and generally governing alerts triggered by gathered sensor data). Collaboration service policies, such as the collaboration engagement, alerts, and support service policy 118, generally govern connection, operation, security, and privacy restrictions for industry compliant collaboration, alerting, and notification services, as may be relevant across a variety of vertical industries.

An autonomous deployment architecture can have flow-through policy integration to achieve remote service automation in respect to installation, activation, operation, and business process integration of services deployed in a remote sensor network location. This functionality is referred to herein as policy based service automation functionality.

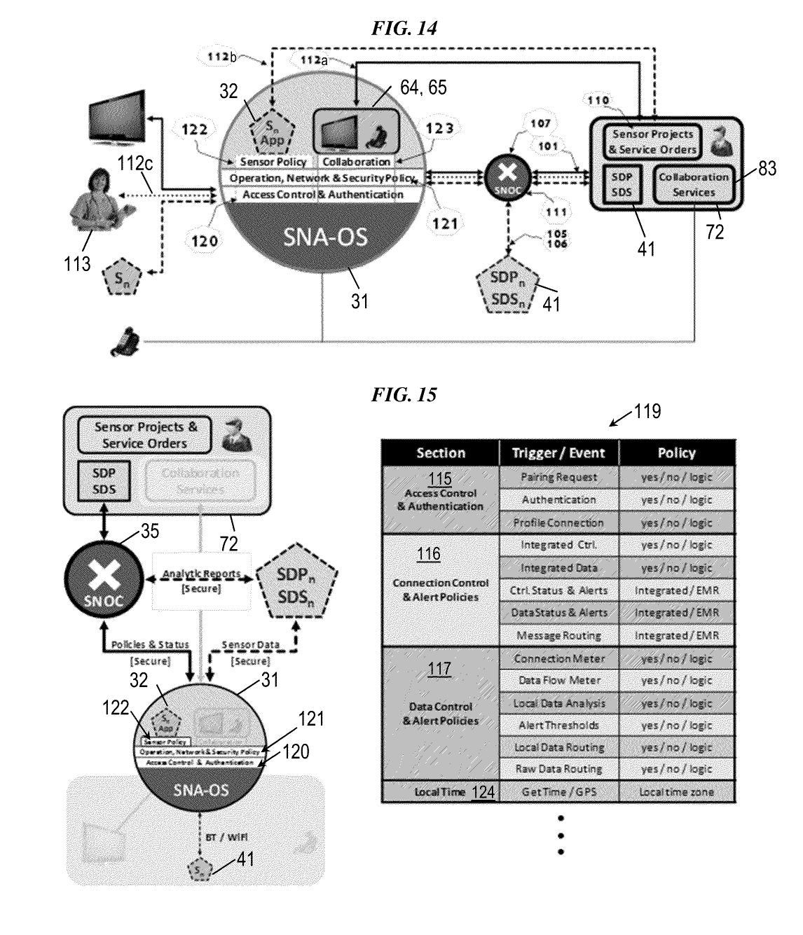

FIG. 14 illustrates an example of an autonomous deployment architecture having policy based service automation functionality. For ease of explanation, the system of FIG. 14 uses the system of FIG. 13 by way of example. As shown in FIG. 13, the information exchange interface 101 spanning between the data and message exchange function 107 of the SNOC 35 and the enterprise 72 can be configured to implement an industry compliant data and message exchange model between the SNOC 35 and the enterprise 72 to exchange service policies as related to vertical business processes 110. The embedded SNOC data and message exchange function 107 can be configured to transform and forward service policy messages along communication lines 112a, 112b, 112c to the SNOC cloud database 111 for storage. The SNOC 35 can be configured to relay the received service policies to the API and control layer(s) of the related SNA(s), e.g., the SNAs 31, 31a. The API and control layer(s) can be configured to store the received service policies and to forward application information to the SNA-embedded apps 32, 64, 66 (and apps embedded on any other related SNAs) via an embedded sensor policy API 122 for sensor apps (e.g., app 32) in accordance with the sensor policy control, data flow, and privacy service policy 117 and via an embedded collaboration policy API 123 for multi-media apps (e.g., apps 64, 65) in accordance with the support service policy 118.

The API and control layer 51 of the SNA 31 is illustrated in FIG. 13 as being decomposed in two sub-layers: an access control and authentication layer 120 and an operations, network and security layer 121. The access control and authentication layer 120 can be configured to manage wireless and wired device access according to the related access control and automation authentication service policy 115, which can include device authentication and access control of wirelessly attached sensors such as the sensor Sn, authentication and access control related to locally connected personnel 113, and control of multi-media channels attached to the related SNA 31 in the context of collaboration service policies. The access control and authentication layer 120 can be configured to use the open and global standards based service interface drivers of the SNA's operating system. The operations, network and security layer 121 can be configured to govern the operation of all centrally managed SNA sub-systems, including the highly secure and encrypted transport and messaging interface 52 to the SNOC 35, according to the operation networking and security service policy 116. The operations, network and security layer 121 can be configured to manage and secure other data and collaboration network channels while protecting the related SNA 31 from unauthorized access.

FIG. 15 illustrates an example of a wireless sensor service policy template 119 for a wireless sensor service via the SNA 31 in the autonomous deployment architecture of FIG. 14. The service policy template 119 is a generalization to ease explanation of policy based service management functions in the context of a remote monitoring service using SNA attached wireless sensors and can include more or less detail than shown in FIG. 15.

The access control and authentication layer 120 can be configured to enforce sensor related access control and authentication policies 115, as received by the SNOC 35, using open and standards based wireless sensor access protocols.

The operations, network and security layer 121 can be configured to enforce the connection control and alert policies 116, as received by the SNOC 35, using open and standards based networking and security protocols to enforce system security and information integrity. The connection control and alert policies 117 can govern routing and security of related connection and status messages, directly exchanged between the SNA 31 and the SNOC 35. The operations, network and security layer 121 can be configured enforce time and location policies 124, as received by the SNOC 35, using open and standards based network time and location protocols, to enforce system synchronization with attached devices and to make adjustments according to local SNA time zones, as they may vary across a cloud-based service network geography. The sensor policy API layer 122 can be configured to forward resulting time and location information to embedded sensor and service control apps 32.

The sensor policy API layer 122 can be configured to enforce sensor data related data control and alert policies 117, as received by the SNOC 35. The sensor data related data control and alert policies 117 can govern local sensor data analysis and alert generation services, as well as related status messages, exchanged between the SNA embedded sensor policy API layer 122, the SNOC 35, and (if present) the third party SDS and SDP sub-system 41 associated with the raw data flow from the relevant sensor Sₙ. The sensor data related data control and alert policies 117 can govern service provisioning and message exchange between the third party SDS and SDP sub-system 41 and the SNOC 35, which can allow business process integration at the enterprise level, e.g., allow the exchange of analytic data reports. The third party SDS and SDP sub-system 41 can be granted use of the integrated data and message exchange function 107 of the SNOC 35 and its industry compliant, secure information exchange interface 101 connectivity.

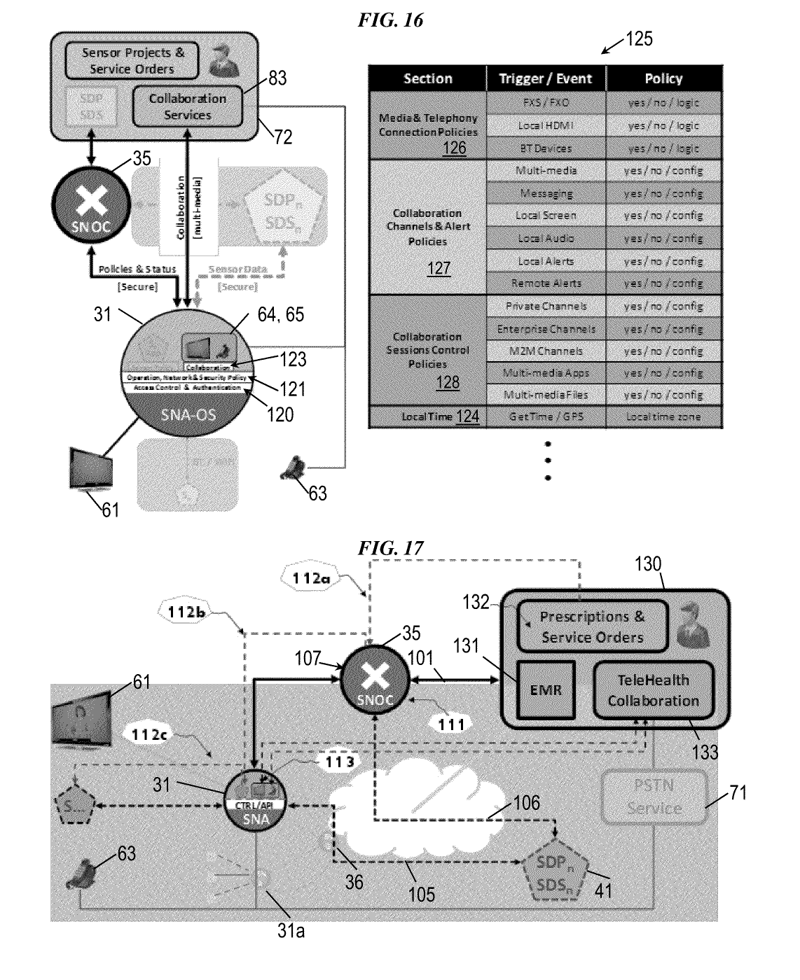

FIG. 16 illustrates an example of a collaboration service policy template 125 for a remote collaboration service via the SNA 31 in the autonomous deployment architecture of FIG. 14. The collaboration service policy template 125 is a generalization to ease explanation of policy based service management functions in the context of a remote monitoring service using collaboration services and can include more or less detail than shown in FIG. 16.

The access control and authentication layer 120 can be configured to enforce media and telephony connection policies 126, as received by the SNOC 35. The media and telephony connection policies 126 generally govern physical connections used by SNA-attached multi-media devices 61, 63, and their association with logical channels used by the apps 64, 65 associated therewith, in conjunction with centralized telephony and collaboration services.

The operations, network and security layer 121 can be configured to enforce collaboration channels and alert policies 127, as received by the SNOC 35, using open and standards based networking and security protocols to enforce system security and information and communication privacy. The collaboration channels and alert policies 127 can govern routing and security of related service channels, channel control and status messages, as exchanged between the embedded the multi-media apps 64, 65, the SNOC 35, and the centralized collaboration services 83. The operations, network and security layer 121 can be configured enforce time and location policies 124, as received by the SNOC 35. The collaboration policy API layer 123 can be configured to forward resulting time and location information to embedded collaboration service control apps 64, 65.

The collaboration policy API layer 123 can be configured to enforces collaboration sessions control policies 128, as received by the SNOC 35. The collaboration sessions control policies 128 can manage local multi-media services, as well as authenticated collaboration sessions between participants within and external to the enterprise 72. The collaboration sessions control policies 128 can be used by the embedded collaboration service control apps 64, 65.

As mentioned above, the autonomous deployment architectures described herein can be used in a variety of contexts. An exemplary context for the autonomous deployment architectures described herein is a health care context in which enterprises in the autonomous deployment architecture relate to health care (e.g., treatment of patients) and telemedicine (e.g., using telecommunication technology to provide health care, particularly helpful in providing health care to a remotely-located patient). Thus, the enterprises can relate to the standards and regulatory health care information technology (HIT) framework applicable to a particular jurisdiction, e.g., the United States or other countries, etc.

FIG. 17 illustrates an example of an autonomous deployment architecture in a health care context. The autonomous deployment architecture of FIG. 17 is similar to the autonomous deployment architecture of FIG. 13 and includes the features thereof except that the generally represented enterprise 72 in FIG. 13 is a health care enterprise 130 in FIG. 17. The features of the health care enterprise 130 correspond to the features of the general enterprise 73 of FIG. 13 but are particularly in a health care context. In particular, the vertical business processes 110 of FIG. 13 related to sensor projects and service orders correspond to vertical business processes 132 related to prescriptions and service orders in the enterprise 130, the SDP and SDS sub-system 41 of the enterprise 72 of FIG. 13 corresponds to an electronic medical record (EMR) sub-system 131 in the enterprise 130, and the collaboration services 83 of FIG. 13 correspond to telehealth collaboration services 133 in the enterprise 130.

The vertical business processes 132 can be configured to allow integrated delivery of prescription (Rx) based telemedicine, e.g., telecare, telehealth, and patient monitoring services. The prescriptions of the vertical business processes 132 can include a medical, provider-generated, electronic service order that is transmitted to the SNOC 34 via standard HIT protocols, such as by being based on the Health IT Layer 7 (HL7) standard. The prescription can thus be a health care specific form of an automated ordering system. In an exemplary implementation, the service location can be outside of a care provider's primary or hospital facilities. For example, the service location can be local to a care provider's patient at a private home, apartment, managed care apartment, nursing home, etc. For another example, the service location can be local to medical facilities other than the care provider's primary or hospital facilities, such as at senior care facilities that have similar service needs and operational requirements as the care provider's primary or hospital facilities.

Installation, deployment, and remote service operation can be integrated with standard prescription delivery processes. Government policies stipulate the use of EMR systems, such as the EMR sub-system 131, resulting in an automated flow-through service ordering paradigm using at least the communication line 112a, e.g., using the communication lines 112a, 112b, 112c. EMR sub-systems are generally used to manage patient population identities, as well as a patient's prescriptions, doctor visits, hospital visits, and other functions of the medical service delivery process. Existing ordering sub-systems of EMR systems issue prescriptive HL7-based orders for medication, education, training or laboratory services, amongst others. EMR systems also offer SDS and SDP functionality, recording and analyzing multiple instances of laboratory results, vital data measurements, and other data related to the diagnostic information base of a given patient. EMR information contains highly condensed analytic data to facilitate fast access and effective diagnostic interpretation for clinicians and primary care physicians. All EMR data can be presented in the context of protected health information (PHI) identifying a specific patient.

From an HIT sub-system separate from the EMR sub-system 131, namely the telehealth collaboration sub-system 133, care providers can offer highly regulated and secure multi-media collaboration services, which can be based on enterprise grade, multi-media private branch exchange (PBX) systems. Such systems are traditionally used in tele-health applications, typically between providers intra-facility. The telehealth collaboration sub-system 133 can be connected to the public telephony service 71, which can be used to contact patients, such as through the telephone 63.

In the context of remote health monitoring services, raw sensor data from the sensors S₁, . . . Sₙ; Sₖ, . . . Sₘ can be centrally collected in third party SDS/SDP sub-systems, such as the third party SDP and SDS sub-system 41 shown in FIG. 17. The third party SDS/SDP sub-systems can be offered as part of the remote sensor service. This external, third party SDS/SDP sub-system can be used to aggregate and store raw sensor data and/or to provide further analytic services, e.g., by analyzing data using a processor. In the context of medical and diagnostic services, the resulting analytical data reports can subsequently be provided to and used efficiently by car providers such as clinicians and primary care physicians, especially when delivered as an integrated part of the patient's resident EMR information base such that the care provider receives a more comprehensive picture of the patient's condition.

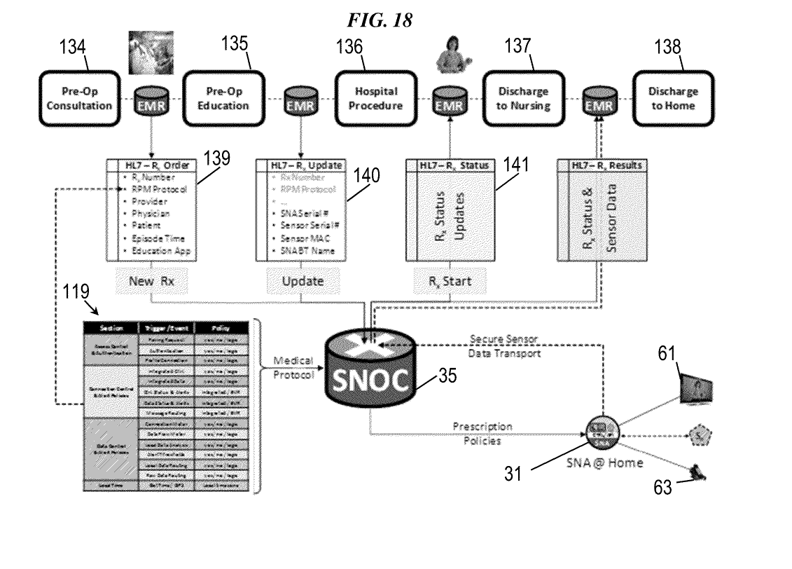

FIG. 18 illustrates an example of a prescriptive automation of post-operative episodic care path using the autonomous deployment architecture of FIG. 17 and the wireless sensor service policy template 119 of FIG. 15, although other autonomous deployment architectures and other templates described herein can be similarly used. The flow-through policy provisioning of the prescriptive automation can create fully automated delivery of a sensor-based remote patient monitoring project, integrated with open HIT-standards based prescriptive processes, in this illustrated implementation in the context of post-operative episodic care.

An upper portion of FIG. 18 illustrates a standard patient care path involving an operational procedure (e.g., a surgical procedure) being performed on the patient as part of the patient's care. The care path can include a series of stages, during each of which a portion of the patient's care can take place, with each of the portions collectively defining a prescription and care delivery process for the patient. Between each of the stages the patient's EMR can be updated in the EMR sub-system 131 to reflect information gathered during the previous stage, thereby allowing the following stage to be based on accurate, current information. As end result of the EMR updating, a remote patient monitoring (RPM) prescription solution can be automatically delivered and activated in the patient's home without any patient interaction by being transmitted from the enterprise 130, e.g., from the EMR sub-system 131 thereof after a discharge to nursing stage 137, to the SNOC 35 and then to the SNA 31. The SNA 31, once installed locally at the patient's home, can be configured to automatically commences pairing and connection establishment with the exact sensor(s) assembled for the prescription (e.g., the ones of the sensors S₁, . . . Sₙ that are part of the patient's post-op treatment plan) based on policy information delivered from the enterprise 130 to the SNOC 35 as part of the prescription driven ordering process. The SNOC 35 can be configured to augment the policy information from the enterprise 130 with additional policy information from the definition of the specific medical RPM protocol. Aggregate policy flow-through provisioning of the SNA 31 can thus enable fully automated RPM operation and policy driven data collection.

FIG. 18 illustrates an example of prescriptive automation through pre-definition of a repeatable medical and technology protocol, governing any deployment of a specific RPM protocol. This information can include the medical protocol associated with a specific RPM protocol and can include sensor specific equipment and configuration policies, augmented with generic wireless sensor service policies, as previously described with respect to FIG. 15. The resulting medical RPM protocol information can be assembled and stored as an RPM protocol template identified by a unique RPM protocol number, which is shared between the EMR sub-system 131 and the SNOC 35.

More particularly, the stages in this illustrated implementation include, in order, a pre-operative (pre-op) consultation stage 134 that generally includes the patient and the patient's care provider(s) discussing treatment options, a pre-op education stage 135 that generally includes the patient's care provider(s) educating the patient about the selected operative treatment, a hospital procedure stage 136 that generally includes the surgical procedure is performed, a discharge to nursing stage 137 that generally includes the patient being cared for at a medical facility post-operation, and a discharge to home stage 138 that generally includes the patient returning home. In the pre-op consultation stage 134 the patient can see their clinician, during which time a decision can be made to carry out a specific hospital procedure at a later time. At this point, the clinician can enter the patient's initial care path and planned procedure data into the patient's EMR, e.g., into the EMR sub-system 131 for the enterprise 130 associated with the clinician, which can include selection of the appropriate post-op RPM protocol. This initial EMR entry can result in an HL7 Rx order 139 from the EMR (e.g., the EMR sub-system 131) to the SNOC 35, which can contain care provider, patient, and medical protocol specific data. The HL7 Rx order 139 can include an RPM protocol number, thereby allowing the SNOC 35 to identify the appropriate RPM protocol template 119, which contains all of the repeatable policy information, as discussed above.

The pre-op education stage 135 to help educate the patient beyond the initial consultation can be an optional part of pre-op activity although it is generally recommended to help keep patients informed and/or help clinicians understand patient involvement pre-operation. In the pre-op education stage 135, the clinician can prescribe pre-op education to the patient to help inform the patient about their treatment, and in particular the upcoming hospital procedure and recovery therefrom. The education can be, for example, in the form of an interactive or streaming video application. An education app can be pre-loaded on the SNOC 35 as part of the RPM protocol template 119 and can be installed automatically on the SNA 31 in response to the triggering of the RPM protocol template 119, e.g., in response to the education being prescribed. This can allow local display or interactive consumption of education material at the patient's home, e.g., on the patient's TV screen at home. The SNA 31 (e.g., the education app installed thereon) can be configured to automatically capture active patient participation as related to the pre-op education and can be configured to automatically report the captured information to the patient's EMR (e.g., to the EMR sub-system 131 via the SNOC 35), which can help prove compliance for related insurance payments and/or allow the clinician to provide feedback to the patient regarding the patient's education progress (e.g., remind the patient to use the education app, ask the patient questions about viewed videos, provide praise to the patient for repeated use of the education app, etc.). The captured active patient participation can include information such as date/time stamp of education app access and features of the education app accessed (e.g., videos watched, electronic informational pamphlets accessed, etc.).

As preparation for performance of the surgical procedure, e.g., before the hospital procedure stage 136, all ordered sensor and SNA equipment can be assembled for delivery to a care provider associated with the enterprise 130, e.g., a nurse, etc., for installation, patient training, and RPM test/operation at the hospital, skilled nursing facility, or other medical facility. The sensor and SNA equipment can be scanned and inventoried in the providers' ordering system for warranty and legal reasons, which can include capturing serial number and media access control (MAC) address information and electronically forwarding the captured information to the SNOC 35, e.g., in form of an HL7 Rx update message 140 for updating of the HL7 Rx order 139 at the SNOC 35. The updating of the HL7 Rx order 139 based on the HL7 Rx update message 140 can complete required technical information for the fully automated, policy controlled operation of any RPM prescription by the associated SNA 31.

Legal consent may be needed, namely authorization by the patient to carry out the RPM prescription, including capture and storage of sensor data and/or explicit authorization for optional involvement of home care providers (e.g., medical personnel, family members, etc.). Related executed legal document and information can be delivered to the SNOC 35 in the HL7 Rx order 139 and/or in the HL7 Rx update message 140. The SNOC 35 can be configured to archive the received executed legal document and information prior to first activation of the RPM equipment. In the event that alerts and/or alarms are to be issued by the SNA 31, e.g., alerts to home care providers or the patient, the HL7 Rx order 139 and/or in the HL7 Rx update message 140 should contain all required delivery information (e.g., name, address (electronic or paper mailing), phone number, etc.) where such alerts and/or alarms should be sent.

Following performance of the surgical procedure, e.g., after the hospital procedure stage 136, the delivered RPM equipment can be unpacked, connected, and installed by a nurse or other trained personnel in order to verify readiness for installation in the home of the patient, which in an exemplary implementation is self-installation by the patient. The delivery can occur prior to discharge of the patient from the medical facility (e.g., hospital, clinic, etc.) where the surgical procedure was performed or after the patient is discharged from the medical facility where the surgical procedure was performed to another medical facility (e.g., a rehab hospital, a nursing home, etc.). The SNOC 35 can be pre-programmed (e.g., via the HL7 Rx order 139 and the optional HL7 Rx update message 140 related thereto) to automatically recognize and provision the SNA 31 upon its installation, as well as to enable the SNA 31 to automatically pair and connect all assembled sensors (e.g., the sensors S₁, . . . Sₙ associated with the SNA 31). The technical part of the initial RPM prescription activation can thus be a fully automated process and can be easy to carry out by a nurse or other trained personnel. The SNOC 35 can be configured to update the patient's EMR (e.g., the EMR sub-system 131) indicating successful activation of the RPM prescription with an HL7 Rx status message 141 transmitted to the enterprise 130.

Following performance of the surgical procedure, e.g., after the hospital procedure stage 136, the patient can receive hands-on training pertaining to use and handling of the related sensor equipment and/or pertaining to the home installation of the SNA 31. Optionally, the RPM prescription can remain active at this time, e.g., for data capture during a transitional stay of the patient at a skilled nursing facility.

Following installation of the SNA 31 in the home of the patient, automated operation of the RPM prescription can commences as soon as sensors related thereto are in pairing mode. The SNOC 35 can be configured to transmit to the EMR, in accordance with the RPM protocol template 119, one or more HL7 Rx status messages 141 reflecting detected alarm conditions and one or more HL7 Rx result messages 142 containing captured sensor data. The SNOC 35 can be configured to stop transmitting the HL7 Rx status messages 141 and the HL7 Rx result messages 142 when the RPM prescription episode elapses, e.g., expires in accordance with an predetermined end date.

In response to the RPM prescription episode elapsing, the SNOC 35 can be configured to automatically un-pair the sensors and to automatically force active operation of the RPM prescription to cease. All data capture and forwarding to EMR sub-system 131 related to the ended RPM prescription can end, and the enterprise 130 can no longer receive pertinent medical information from the RPM equipment or service. The SNOC 35 can be configured to provide the enterprise 130 with a final status report capturing relevant events, as logged and archived during the operational phase of the RPM prescription episode.

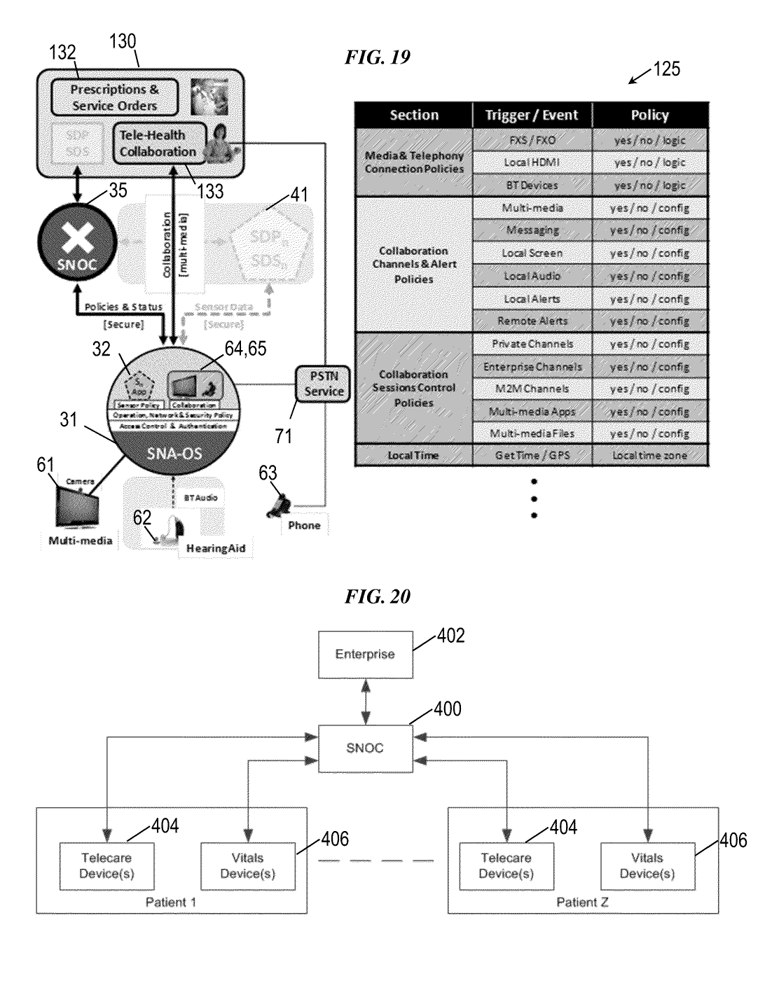

FIG. 19 illustrates an example of an automated integrated telehealth collaboration service with a patient under care at home using the autonomous deployment architecture of FIG. 17 and the collaboration service policy template 125 of FIG. 16, although other autonomous deployment architectures and other templates described herein can be similarly used. The automated integrated telehealth collaboration service can allow automated alert and messaging services delivered to care providers of the patient (e.g., care staff, family members, etc.). The patient can pre-authorized the care providers to receive such information, e.g., as part of the patient consent process integrated with hospital procedures. The prescriptive flow-through of the automated integrated telehealth collaboration service can allow the definition of the collaboration service policy template 125. Auto-detection of authorized phone and multi-media connections, as well as prescribed wireless audio devices, such the hearing aid 62, can allows the SNA embedded collaboration service control apps 64, 65 to offer integrated and interactive telehealth collaboration services, such as virtual office visits, virtual home care visits, alert driven call-backs, emergency notification services, and many more.

The concurrent operation of the SNA embedded sensor and service control apps 32 and the SNA embedded collaboration service control apps 64, 65 can allow prescriptive control of a rich variety of integrated care paths, including home based patient education, interactive patient training, video and image streaming, and many more.

Following the authorization by the patient, fully automated video conferencing sessions, e.g., between family members, etc., can be remotely arranged (pre-arranged or arranged in real time) and announced to the patient at home in real-time with the start of the session, e.g., with an automated phone call reminder. This can allow hands-free operation and participation of the patient in media rich collaboration and communication sessions.

In a health care context, the autonomous deployment architectures described herein can be configured to provide prescriptive care path automation. More particularly, the autonomous deployment architectures can be configured to provide flow-through provisioning that creates fully automated delivery of complete medical multi-sensor care paths, where recorded data from a plurality of sensors using a plurality of software applications and a plurality of SDS/SDP storage and processing methods can be aggregated and interpreted by automatically downloaded and configured care path applications (care path apps) and then stored in an anonymous data storage repository. From the data storage repository any authorized party can obtain, in an automated process or as explicitly requested, detailed and historic care path reports.

An open API and control layer embedded in an SNA can be configured to interact with any care path apps embedded in the SNA and can securely connect to a SNOC, similar to that discussed above regarding SNA embedded sensor and service apps. For ease of explanation, an exemplary implementation of care path apps is described below with reference to the example of the autonomous deployment architecture of FIG. 17. This and other implementations of care path apps can be deployed in other autonomous deployment architectures described herein.

The SNOC 35 can be configured to automatically download from the enterprise 131 a set of pre-defined applications that are specific to the requested care path, including applications that are configured to further aggregate and interpret data recorded by multiple sensors (e.g., the sensors S₁, . . . Sₙ associated with the patient, the sensors Sₖ, . . . Sₘ associated with another patient, etc.), or that are configured to receive sensor data from multiple SDS/SDP sub-systems 41. These downloaded applications, the care path apps, are independent of the sensor and service apps 32 that are typically offered by sensor manufacturers. The sensor and service apps 32 can be installed automatically, as discussed above, in accordance with the medical RPM protocol that is specified as part of the service policy template associated with the care path of the patient, e.g., the RPM protocol template 119 of FIGS. 15 and 18, and can be offered separately by different sensor vendors.

The care path apps installed on the SNA 31 can be configured to provide a local abstraction layer, aggregating raw or post-processed sensor data and other information that can be obtained from several sources, in preparation for vendor independent and aggregated storage in the care path repository of any given patient. The care path apps can thus be configured to provide a real-time data recording function as part of an aggregated and automated care path. Similar to that discussed above regarding sensors and collaboration, the API and control layer 51 of the SNA 31 can be configured to forward application information to the SNA-embedded care path apps via an embedded sensor policy API for care path apps in accordance with the service policy associated with the care path of the patient.

Example sources of sensor data can be directly accessible sensor data, collected by the embedded sensor and service control apps 32 that support a vendor specific or industry standard embedded SNA API. Sensor data can be configured to be obtained indirectly by an embedded care path application from the SDP/SDS sub-systems 41 of a plurality of third party vendors, e.g., via standard data exchange technology or API. Such SDP/SDS sub-systems 41 can be the care provider's own EMR sub-system 41 at the enterprise 130, using HL7 communication methodology, or any other suitable and legally compliant electronic repository system.

The care path apps installed on the SNA 31 can be configured to, following aggregation of sensor specific raw or post-processed data, patient entered data, system-generated data, or any other information from multiple sources, logically interpret the aggregate data record in real-time and in context of specific care path directives. For legal compliance reasons, the logic contained in care path apps can be configured to not modify received sensor or patient entered data in terms of its nature, value, or content, but instead be configured to aggregate, logically interpret, and reflect the aggregated data in context of a pre-defined care path.

The care path directives can include a set of patient-specific parameters established in conformance with a pre-defined care plan template and ordered specifically in the context of a patient's care path protocol. The care path directives can be loaded at the SNA 31 for embedded program execution by associated embedded care path apps in specific context of a given patient ID. The care path directives can be configured to provide parametrization for the logic interpretation algorithms and the processing of triggered events by the care path apps. The care path directives can be configured to serve as fully automatable input for embedded logic of their associated care path apps. The care path directives can contain information about the data sources to be aggregated, the aggregation methods to be used, algorithmic comparison and threshold parameters, triggered event and related distribution lists, and other information. The care path directives can be configured to direct interpretation, alerting and reporting functions, included in specific care path apps to execute specific actions, such as triggers, reports, graphic displays, run-time time schedules, etc. The care path directives can contain template data that can be exchanged via HL7 messaging (or any other electronic messaging interface) to facilitate prescriptive deployment and the full automation of patient and care path specific medical monitoring, alerting, and reporting functions.

The SNOC 35 can be configured to store and manage the care path apps and directives and, upon request by the ordering provider (e.g., at the enterprise 130), can be configured to facilitate automatic download thereof to the SNA 31 via the operations, network and security layer 121. The SNA 31 can be configured to install the care path apps and directives using the API and control layer 51, e.g., using an embedded care path control layer of the API and control layer 51. The embedded care path control layer, e.g., a care path API, of the SNA 31 can be configured to support initial download, version control, installation, and subsequent operation of the care path apps and directives. The care path API can be configured to support generic SNOC event communication of real-time notifications, e.g., alerts from by data processing algorithms embedded in care path apps, etc. The care path API can be configured to provide care path apps installed on the SNA 31 with required anonymous context information for subsequent patient data repository storage and/or repository access. The anonymous context information can be generated in a secure context by the SNA 31, e.g., the access control and authentication layer 120 thereof, in accordance with Health Insurance Portability and Accountability Act (HIPAA) privacy rules, and the anonymous context information can serve to logically disconnect PHI information from any locally generated data records or events.

The operation of SNA embedded care path apps can be configured to generate events in accordance with parameters specified in associated care path directives. These events, referred to herein as care path notifications, can include, e.g., informational events, technical status events and alarms, medical alerts, etc. In general, care path notifications can provide a real-time reflection of the operation of the embedded care path apps and can be used to minimize system and user reaction time in case of critical conditions, e.g., in case of gathered sensor data being outside a predetermined safe range, etc. The embedded care path API can be configured to support the transport of care path notifications to the SNOC 35, e.g., to the collaboration service policy template 125 referred to by the active care path template. The embedded care path API can be configured to determine to whom the care path notifications events are to be transmitted, in which format, with which information content restrictions, and which collaboration channel to use. The care path directives can instruct the care path apps what kind of care path notifications should be issued in the context of alerts and/or on what regular time schedules such reports should be issued.

The system can include a storage device for care path data storage, also referred to herein as a “care path repository” or “care path repository server.” The care path repository server can include only anonymous information, such as aggregate data sets, alerts, reports, that can be referenced through appropriately authorized secure access methods for further processing. In other words, the only anonymous information, such as aggregate data sets, alerts, reports, that can be referenced through appropriately authorized secure access methods for further processing can not contain PHI, as defined in the United States under HIPAA, but only anonymous information. Further processing instances can combined or re-combine anonymous information with the PHI to generate specific reports, alerts, graphs, and/or further analytics, in the context of a specific patient, all of which will only be accessible to pre-authorized persons and care takers through the use of these secure access methods.

The care path repository server can be configured to facilitate care path data reporting. The care path apps executing locally at the SNA 31 can be configured to process data aggregated in the care path repository server, and can be configured to, as instructed by associated care path directives, generate alerts and/or reports and send them to the SNOC 35 for cloud-based processing and/or display and/or to be sent to third-party processing and/or storage systems, e.g., via HL7 to a provider's EMR (e.g., to the EMR sub-system 131). All such related aggregate data sets, alerts, reports, care path directives, and other information, can be archived and stored in anonymous format in the care path repository. From the care path repository, the information stored therein can be accessed for legal, medical, reporting, and/or analytics processing at a later point in time. To ensure security, the access can use unique and secure access credentials for the retrieval of the care path repository information. Presenting these secure access credentials, pre-authorized post-processing functions can then combined or re-combine autonomous care path repository information with the PHI of a given patient.

FIG. 20 illustrates another example of an autonomous deployment architecture in a health care context. As with the other examples of autonomous deployment architectures described herein, the autonomous deployment architecture of FIG. 20 can include any of the autonomous deployment architecture functionalities described above. As illustrated, a SNOC 400 can be configured to electronically communicate with an enterprise 402 and with one or more devices for each of a plurality of patients. The variable “Z” in FIG. 20 represents a number of patients and is a whole number equaling two or greater. Each of the devices can include an SNA, e.g., an app downloaded via the SNOC 400, and can include a computer system. Users thus need not log in to the cloud (e.g., the SNOC 400) to receive and use apps installed locally (e.g., installed on mobile devices or other client terminals). As illustrated, each of the patients can have associated therewith at least one telecare device 404 and at least one vitals device 406. In other examples, a single device can provide telecare functionality and vitals functionality. The one or more telecare devices 404 and the one or more vitals devices 406 can be configured to communicate with the SNOC 400, and vice versa, such that data can be transmitted therebetween, as discussed above. Also, the SNOC 400 and the enterprise 402 can be configured to communicate data therebetween, e.g., for EMR purposes, etc., as discussed above.

The telecare device 404 can be configured to facilitate telecare services for the patient with which the telecare device 404 is associated and to facilitate telecare services for the patient's home care providers (e.g., family, friends, etc.). In an exemplary implementation, the telecare device 404 can include a television, which can facilitate ease of use and access to the telecare services since most users are familiar with general TV functionality and can interact with the TV to use the telecare services with little to no TV-use training. In this way, patients of any age can be able to easily access the telecare services via the telecare device 404. The telecare services can thus be available to the elderly, to children, and/or to users with limited access to technology, which are populations that may otherwise be excluded from home health care management solutions due to lack of technological understanding and/or lack of technology access.

The telecare services configured to be facilitated by the telecare device 404 can include any one or more of chronic condition monitoring (such as by using sensors associated with the patient as discussed herein that are in electronic communication with the telecare device 404), video and intercom services through the telecare device 404, real-time alerts provided to the patient through the telecare device 404, real-time status and/or other data reports provided to the patient through the telecare device 404, providing real-time patient activity information (e.g., patient motion information as gathered using one or more motion sensors) through the telecare device 404, and virtual care provider home visits via the telecare device 404, which can help provide patient peace of mind and/or a sense of safety at home. Telecare devices 404 that can facilitate telecare services are further described in U.S. application Ser. No. ______ (Attorney Docket No. SNA01 001) entitled “System And Method For Automated Deployment And Operation Of Remote Measurement And Process Control Solutions” filed on even date herewith, which is hereby incorporated by reference in its entirety.

The vitals device 406 can be configured to facilitate HIT management and use for care providers(s) of the patient with which the telecare device 404 is associated. In an exemplary implementation, the vitals device 406 can include a mobile device (e.g., a laptop computer, a mobile phone, etc.), although the vitals device 406 can include a stationary device (e.g., a desktop computer, a television, etc.). By being mobile, the vitals device 406 can allow a care provider to access the functionality thereof at any of a variety of locations, subject to network access.

The HIT management and use configured to be facilitated by the vitals device 406 can include real-time and historical monitoring of vital signs (e.g., using one or more sensors configured to sense vital signs such as temperature, heart rate, blood pressure, spO₂, weight, glucose, activity/motion, sleep quality, ECG, etc.), real-time alerts provided to the care provider through the vitals device 406, real-time and historical status and/or other data reports provided to the care provider through the vitals device 406, real-time and historical co-morbidity monitoring, EMR integration, real-time and historical visual (still image and/or video image) wound inspection, nurse call intercom and video services, manual entry of data related to the patient, and perform virtual patient rounds. The HIT management and use can be particularly useful in a post-op scenario as discussed above, after the patient is discharged from a hospital following performance of a surgical procedure, since the care provider(s) can remotely monitor and/or interact with the patient at home or at other location other than a hospital or other medical facility where the care provider(s) typically interact with the patient, and/or since the care provider(s) can be made more quickly aware of any anomalies in patient status such that the anomalies can be more quickly addressed (e.g., by discussing the anomaly with the patient, changing the patient's treatment plan, etc.). The risk of re-admission can thus be reduced.

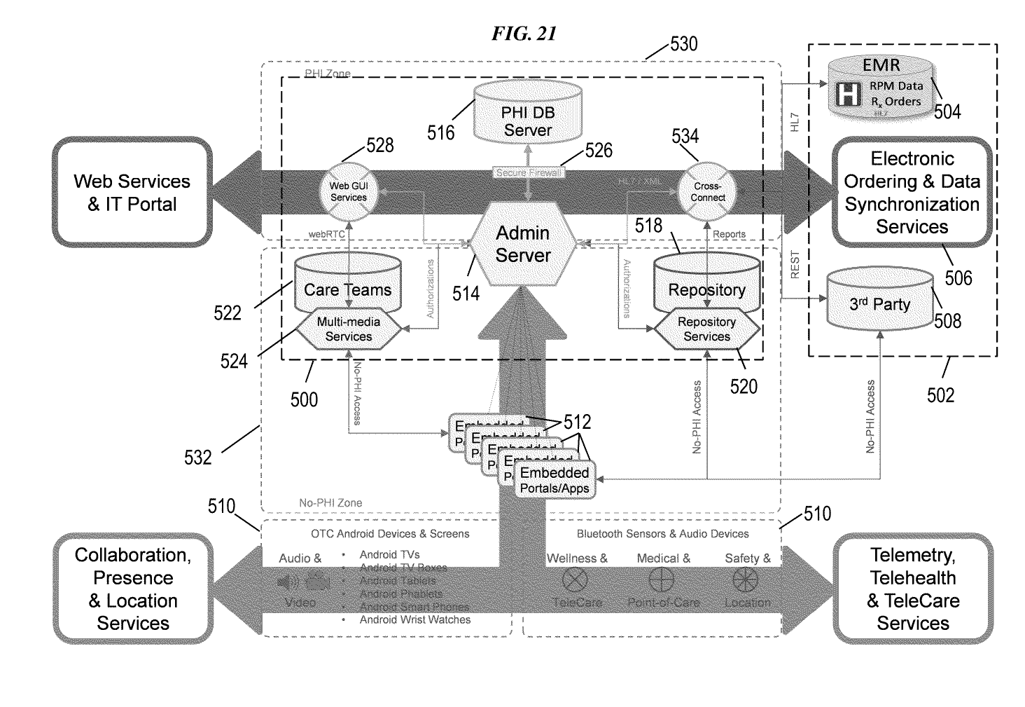

FIG. 21 illustrates another example of an autonomous deployment architecture in a health care context. As illustrated, a SNOC 500 can be configured to electronically communicate with an enterprise 502 and with one or more telecare and/or vitals devices 510 for a patient, with each of the devices 510 having an associated SNA 512. A plurality of devices 510 are shown in this illustrated example. A plurality of embedded portals/apps are shown as the SNAs 512 in this illustrated example, with each of the embedded portals/apps being downloadable according to care path directives and each being configured to control and/or execute one or more functionalities under general control of the SNOC 500, as described herein. Each of these functionalities are also be referred to herein as “sub-functions,” e.g., a reporting sub-function, an alerting sub-function, a collaboration sub-function, sensor control sub-function, GUI display sub-function, data aggregation sub-function, etc.

The enterprise 502 can include an EMR sub-system 504, vertical business processes 506 (e.g., electronic ordering and data synchronization services for a health care enterprise 502 as illustrated), and a sub-system 508 (e.g., an SDP and SDS sub-system). The EMR sub-system 504 in this illustrated example is based on the HL7 standard, but other protocols can be used in accordance with relevant government/security requirements. Only one enterprise 502 is shown in communication with the SNOC 500 in this illustrated example, but the SNOC 500 can be in communication with a plurality of enterprises.

The SNOC 500 can include an administration (admin) server 514 (e.g., a computer system in the form of a server or in another form that includes at least a processor and a network interface), a PHI database (DB) server 516 (e.g., a computer system in the form of a server or in another form that includes at least a processor and a memory), a care path repository 518 for storing anonymous information, care path repository services 520 configured to facilitate access to data stored in the care path repository 518 via user authorization by the admin server 514, a care teams storage device 522 configured to store data regarding the patient's associated care providers, and multi-media services 524 configured to facilitate access to data stored in the care teams storage device 522 via user authorization by the admin server 514. The care path repository services 520 can be controlled via the admin server 514 and/or a repository server in communication with the admin server 514, and the multi-media services 524 can be controlled via the admin server 514 and/or a collaboration server in communication with the admin server 514.

Data transmitted between various elements of the system illustrated in FIG. 21 can be patient-specific so as to be associated with a specific patient (e.g., can include PHI) or can be anonymous (e.g., non-patient specific) so as to not be associated with a specific patient (e.g., does not include PHI). A PHI zone 530 in FIG. 21 indicates where data in the system can include PHI so as to not be anonymous, and a No-PHI zone 532 in FIG. 21 indicates where data in the system can be anonymous. The PHI DB server 516 can be configured to communicate with the admin server 514 over a secure firewall 526 using security features such as data encryption, which can help preserve the privacy and security of data stored at, transmitted to, and retrieved from the PHI DB server 516. The security firewall 526 can thus help keep data secure in the PHI zone 530. The system can include the secure firewall 526 in addition to or instead of other security features to help preserve the privacy and security of data stored at, transmitted to, and retrieved from the PHI DB server 516.

The admin server 514 can be configured to facilitate the provision of web graphical user interface (GUI) services 528 over a network to one or more computer systems, e.g., to provide access to functionality of the SNOC 400 via the Internet instead of via an embedded app on a device but otherwise similar. This communication uses the web real-time communication (webRTC) API definition in this illustrated example, but other protocols can be used. The web GUI services 528 can be configured to communicate with the multi-media services 524 to facilitate the delivery of services to the web and IT portals. The multi-media services 524 can be configured to communicate with the devices 510, e.g., the SNAs 512 thereof, to facilitate the delivery of services to the web and IT portals. This communication can be without PHI access, e.g., in the No-PHI zone 532, as in this illustrated example.

The admin server 514 can be configured to facilitate the provision of cross-connection services 534 between itself and the enterprise 502. The communication between the admin server 514 and the cross-connection services 534 can be transmitted based on the HL7 standard using XML, as in this illustrated example, but data can be transmitted therebetween in additional or alternative ways (in compliance with any required government/security requirements), such as HTTPS and simple object access protocol (SOAP). In general, the cross-connection services 534 can allow for the vertical business processes 506 to be implemented, e.g., to deliver Rx based telemedicine and selection of appropriate templates for a prescription as discussed herein, facilitate automatic SNA app download, facilitate prescriptive automation of post-operative episodic care path, and deliver sensor and other patient-related data to the enterprise 502, e.g., for inclusion in the patient's EMR in the EMR sub-system 504. The cross-connection services 534 can be cloud-based.

The vertical business processes 506 can include electronic ordering of records for patients associated with the enterprise 502, with the admin server 514 being configured to facilitate such ordering via the cross-connection services 534. The electronic ordering of records can be generated from an EMR message, e.g., using data from the EMR sub-system 504. The electronic ordering of records can include facilitating patient admission by creating an HL7 ADT (admit discharge and transfer) message, facilitating lab orders by creating an HL7 ORM (order response message) message, and creating other types of electronic order messages for patients. The created electronic order message for ADT, ORM, or other purpose can include, for example, an identity of the referring care provider (e.g., a national provider identifier (NPI) for the referring care provider and/or a name of the referring care provider) (which can be added to the appropriate care team template so as to allow the identified care provider to have PHI access and receive reports for the patient at issue), an identity of the patient (e.g., social security number and/or PHI), prescription or admission type (which can be added to the appropriate protocol template), care plan parameters (which can be added to the appropriate care plan template so as reflect current conditions and identify parameter(s) that should be measured and/or how the parameter(s) should be measured, such as at what frequency they should be measured and what type of reports should be generated based on the measurements), and device parameters (which can be added to the appropriate device template so as reflect current conditions and allow apps to be automatically downloaded). As discussed above, the templates can facilitate the scalable, automated remote deployment, activation, and operation of such services. The care team template mentioned above can generally govern access and collaboration rights with the patient and indicate which care providers associated with the patient do and do not receive certain alerts and reports (e.g., family members receive alerts regarding medication being due, doctor receives alerts regarding abnormal heart rate measurements, etc.).

The cross-connection services 534 can be configured to communicate with the repository services 520 to facilitate the production and/or providing to users of detailed and historic care path reports, as discussed herein. The repository services 520 can be configured to communicate with the devices 510, e.g., the SNAs 512 thereof, to facilitate the production and/or providing to users of the detailed and historic care path reports. This communication can be without PHI access, e.g., in the No-PHI zone 532, as in this illustrated example.

The admin server 514 can be configured to facilitate the provision of telemetry, telehealth, and telecare services via the SNAs 512 and the devices 510 associated therewith. As in this example, the ones of the devices 510 configured to facilitate these services can include sensors, such as BT sensors and audio devices. The data gathered by the sensors can be used as discussed herein.

The admin server 514 can be configured to facilitate the provision of collaboration, presence, and location services via the SNAs 512 and the devices 510 associated therewith. As in this example, the ones of the devices 510 configured to provide the collaboration, presence, and location services to a user (e.g., to a care provider) can be configured to provide audio and video and can include OTC Android devices such as TVs, TV boxes, tablets, phablets, smart phones, and smart wrist watches. Other devices 510 can be used, however. The collaboration services can include the collaboration services and collaboration functionality discussed herein. The devices 510 can each be configured to have its portal functionality upgraded at any time, e.g., as the scope or application of the portal framework changes. Android is only an example of an embedded operating system that the devices 510 can run; other embedded operating systems can be used. In other words, the embedded applications can be configured to run and be automatically configured and used on any embedded operating system.

The presence services can include providing patient vitals information to care providers in real time. The vitals information can be automatically provided to the SNOC 500, e.g., to the admin server 514, and/or can be provided on-demand in response to a user query. The vitals information can help a care provider determine whether a patient is properly using the device for activity purposes (e.g., whether or not a motion sensor is sensing motion at a time when activity is expected) and/or help a care provider see and/or evaluate the patient's vitals information in real time and/or historically. The care provider can input notes, comments, photos, and/or other data to the patient's EMR in connection with the received vitals information, which can further allow a more complete record of the patient's health and/or wellness to be created and accessible to the patient's care team (in accordance with the various care team members' access rights). As mentioned herein, alerts based on the vitals information can be automatically generated, e.g., by the SNOC 500, in real time and transmitted in real time to the appropriate care providers (e.g., as indicated in the care team template).

The location services can include an ability to query in real time the devices 510 for their presence at a certain location (e.g., at a hospital, at a nursing home, etc.), which can help the care provider determine where the patient is located based on where their associated device 510 is located. The devices 510 can be configured to determine their location in any number of ways, such as by using built-in global positioning system (GPS) functionality, as will be appreciated by a person skilled in the art. The location information can be automatically provided to the SNOC 500, e.g., to the admin server 514, and/or can be provided on-demand in response to a user query. The on-demand query can be for a selected one or more of devices 510 available to the particular user (e.g., based on the user's access rights). By querying a plurality of devices each associated with a different patient, the location information can help care providers conduct a patient census by learning the locations of a plurality of patients based on the locations of the devices (and hence identify if any patients are absent or are not in an expected location), help prevent theft and/or unauthorized device use by determining if any of the devices 510 are in an unauthorized location, and/or help care providers control inventory by determining where devices are located. The SNOC 400, e.g., the admin server 514, can be configured to facilitate the compilation and storage of location information in the repository 518, which can be used to analyze historical information. For example, historical location information can be used to determine where a patient was last located, which can be helpful if a patient is absent from a later-conducted census. For another example, historical location information can be used to determine activities of daily living (ADL) patterns—and deviations therefrom—for a patient by identifying typical daily locations for a patient.

The location services can include automatically determining a location of the devices 510, such as by triggering of a wireless alert when the device 510 moves into proximity of a location sensor, e.g., a wireless sensor mounted on a wall of a hospital room, mounted on a door frame, etc. Such location monitoring can help care providers control inventory, can help determine patient location, and/or can help facilitate the timely dispatch of care providers to locations where patients may need assistance, as determined by the patient's location (e.g., a patient in a physical therapy room needing physical therapy assistance, etc.). In an exemplary embodiment, the patient's identity can be associated with located device, such as by the device 510 can including a BLE sensor device used as an identifying radio frequency identification (RFID) device to establish an identification of the patient. The BLE sensor device can, as discussed herein, include sensor functionality such as activity tracking, sleep tracking, etc.

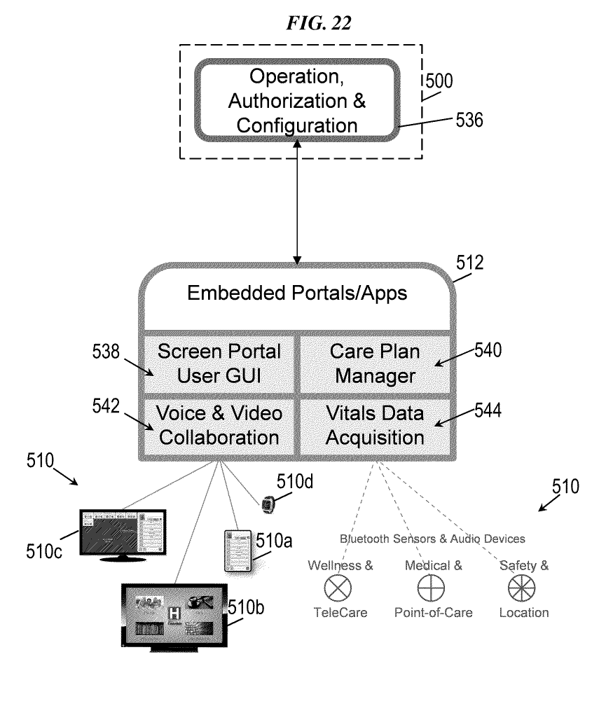

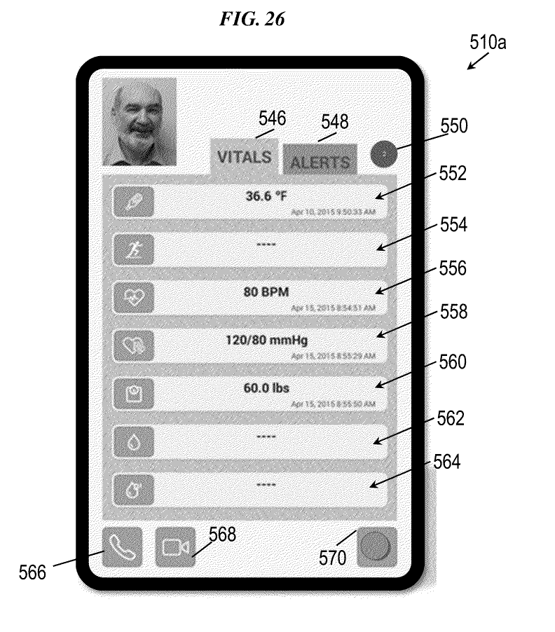

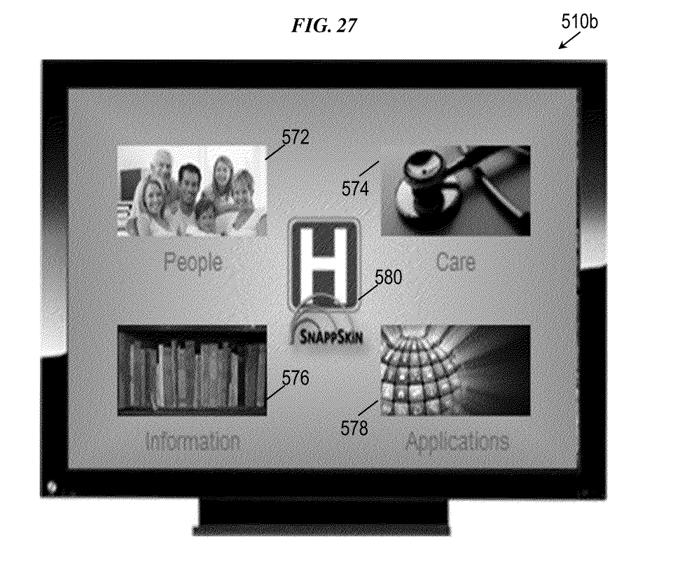

FIG. 22 illustrates an aspect of the system of FIG. 21 including an operation, authorization, and configuration functionality 536 of the SNOC 500 and including one of the SNAs 512 having screen portal user GUI functionality 538, care plan manager functionality 540, voice and video collaboration functionality 542, and vitals data acquisition functionality 544. The other ones of the SNAs 512 can be similarly configured. The operation, authorization, and configuration functionality 536 can be configured to facilitate download of apps to the SNAs 512, to facilitate maintenance of the apps installed on the SNAs 512, to facilitate download of GUI screen parameters to the SNAs 512 (e.g., to the screen portal user GUI functionality 538 thereof), to facilitate maintenance of the GUI screen parameters, to create and maintain an authorized device list (e.g., a list of the devices 510), and to create and maintain an authorized care team list (e.g., a list of care providers authorized to interact with the patient's devices 510). The screen portal user GUI functionality 538 can be configured to facilitate user authorization, screen operation, screen portal configuration, and login options. The care plan manager functionality 540 can be configured to register the device 510 associated therewith, to facilitate data analysis, to manage alerts, and to communicate with the repository 518. The voice and video collaboration functionality 542 can be configured to authorize telephone calls, to provide session control, to provide session path, to control video communications, to control audio communications, and to facilitate BT intercom functionality. The voice and video collaboration functionality 542 can be configured to interface with the ones of the devices 510 configured to provide the collaboration, presence, and location services, which in this illustrated example include a mobile phone 510a (also shown in FIG. 26), a TV 510b (also shown in FIG. 27), and a touch screen client terminal 510c, a smart wristwatch 510d. The vitals data acquisition functionality 544 can be configured to facilitate device control, data acquisition, manual data entry, BT scanning, determination of patient location, determination of device location, and determination of staff (e.g., care provider) location. The vitals data acquisition functionality 544 can be configured to interface with the ones of the devices 510 configured to facilitate the provision of telemetry, telehealth, and telecare services.

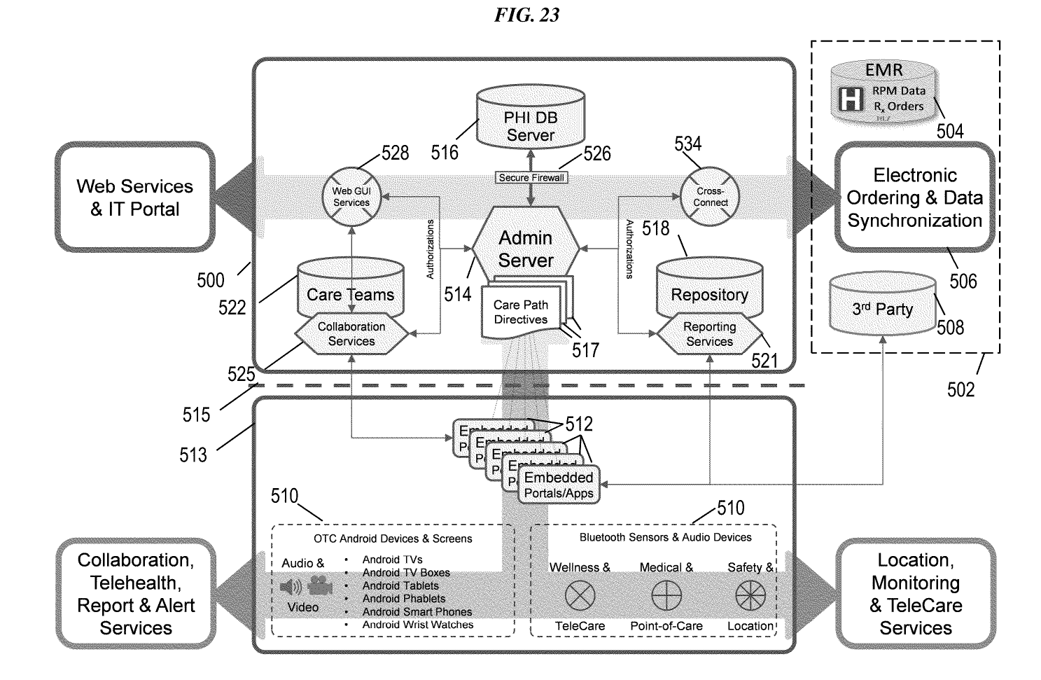

FIG. 23 illustrates another example of an autonomous deployment architecture in a health care context. The architecture of FIG. 23 illustrates the architecture of FIG. 21 with the devices 510 and the SNAs 512 being collectively identified in FIG. 23 as SNAs 513. FIG. 23 also illustrates a control/API layer 515 between the SNOC 500 and the SNAs 513, and illustrates a plurality of care path directives 517 each associated with the SNOC 500 and the admin server 514. As discussed herein, the care path directives 517 can generally each be configured to control the admin server 514 to operate the embedded SNAs 512, which as also discussed herein, can generally include an embedded operating system installed on a client terminal. The creation of the care path directives 517 is discussed in further detail in previously mentioned U.S. application Ser. No. ______ (Attorney Docket No. SNA01 001) entitled “System And Method For Automated Deployment And Operation Of Remote Measurement And Process Control Solutions” filed on even date herewith.

The architecture of FIG. 23 illustrates additional and/or alternative functionality of the architecture of FIG. 21. As shown in FIG. 23, the admin server 514 can be configured to facilitate the provision of collaboration, telehealth report, and alert services via the SNAs 512 and the devices 510 associated therewith. The collaboration services can include the collaboration services and collaboration functionality discussed herein. The telehealth report services can include providing analytical reports, as discussed herein, such as providing analytical reports regarding a patient to the patient's care providers. The alert services can include providing alerts, as discussed herein, such as providing alerts to care providers in real time with data gathering. As also shown in FIG. 23, the admin server 514 can be configured to facilitate the provision of location, monitoring, and telecare services via the SNAs 512 and the devices 510 associated therewith. The location services can include an ability to query in real time the devices 510 for their presence at a certain location, as discussed herein. The monitoring services can include the remote monitoring functionality discussed herein. The telecare services can include the telecare functionality discussed herein. FIG. 23 also shows the care teams storage device 522 configured to store data regarding the patient's associated collaboration services 525 configured to facilitate collaboration between users, and reporting services 521 configured to facilitate the providing of reporting and alerts. The reporting and alert services 521 can be controlled via the admin server 514 and/or the repository server in communication with the admin server 514, and the collaboration services 525 can be controlled via the admin server 514 and/or the collaboration server in communication with the admin server 514.

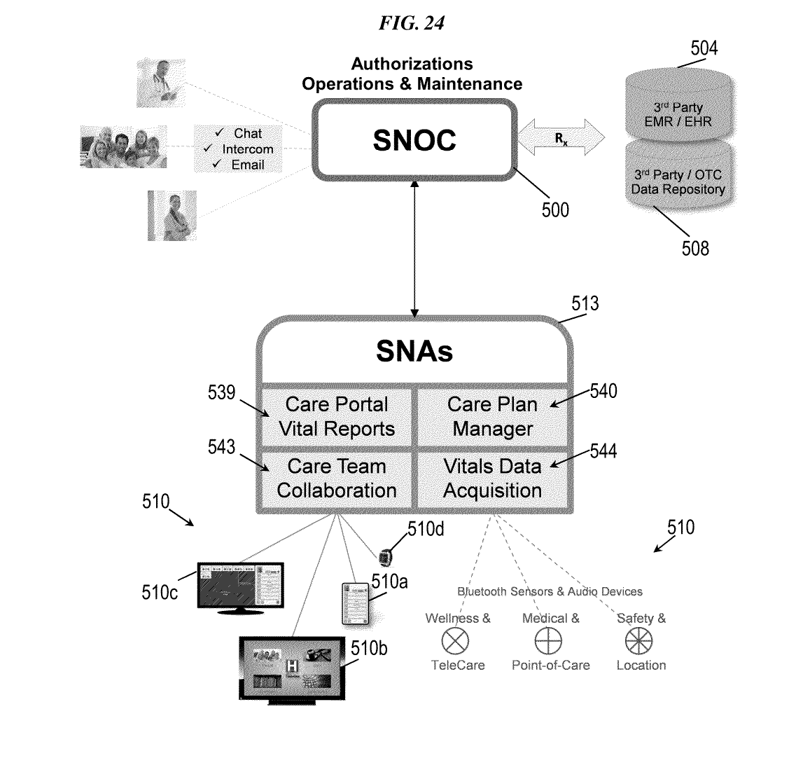

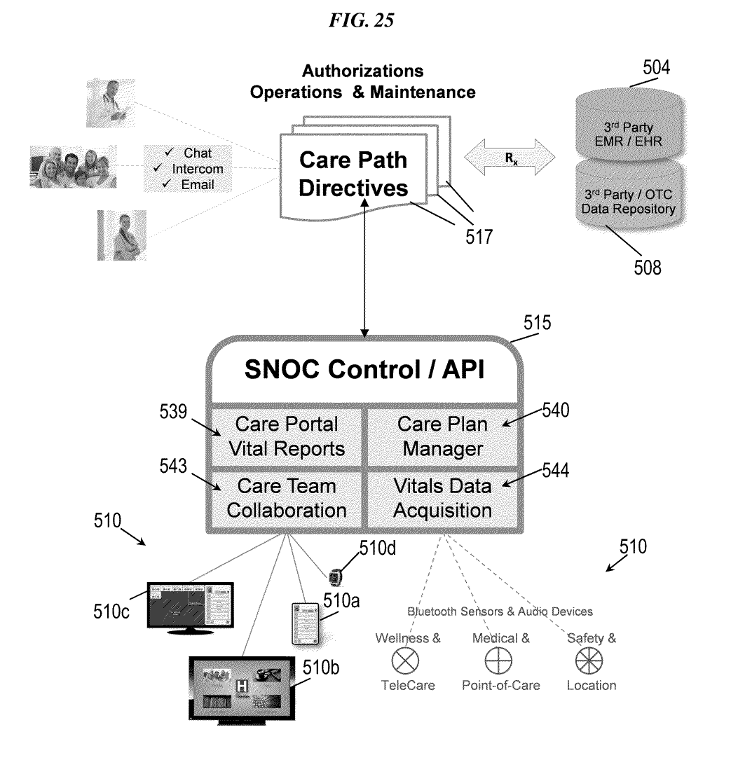

FIGS. 24 and 25 are similar to FIG. 22 and illustrates an aspect of the system of FIG. 23 including an operation, authorization, and configuration functionality of the SNOC 500 and care path directives 517, and including the control/API layer 515 and the SNAs 513 each having care portal vitals reports functionality 539, the care plan manager functionality 540, care team collaboration functionality 543, and the vitals data acquisition functionality 544. The care portal vitals reports functionality 539 can be configured to facilitate login options, user authorization, screen view and operation, and portal view selection and configuration. The care team collaboration functionality 543 can be configured to facilitate communication between care providers, such as call authorization, session control, session path, video control, audio control, and Bluetooth intercom functionalities.

FIGS. 22, 24, and 26 illustrate an example of a portal for the mobile phone 510a configured to provide vitals information for a patient. As discussed herein, access to the portal can be limited based on security credentials. The mobile phone 510a can be a personal, privately-owned client terminal of the user or can be an institutional, employer-owned client terminal which the user is permitted to use. Vitals information can be similarly provided on displays on other types of client terminals. The vitals information is shown because a vitals tab 546 is selected on the screen. Alerts related to the patient can be similarly viewed by selecting an alerts tab 548 on the screen. The screen can include an alerts status 550, which can indicate whether any unviewed alerts and/or unaddressed alerts exist for the patient. In this illustrated example, the alerts status 550 indicates that there are two unviewed and/or unaddressed alerts for the patient. The vitals information and the alerts being accessible on a mobile device such as the mobile phone 510a can allow such information to be accessible at virtually any location.

The portal can be configured to display vitals information for the patient. All available vitals information can be simultaneously displayed, or selected vitals information can be displayed based on patient choice or screen size. Each available vitals parameter can be associated with a sensor, e.g., each of the displayed vitals data can be gathered by a sensor. Some sensors, however, can be configured to gather data regarding more than one parameter such that two or more displayed vitals parameters can be associated with the same sensor. Each of the displayed vitals information can include a date/time at which the information was gathered. In this illustrated example, the vitals information displayed includes temperature data 552, motion data 554, heart rate data 556, blood pressure data 558, weight data 560, glucose data 562, and spO₂ data 564. Each of the vitals information 552, 554, 556, 558, 560, 562, 564 can be configured to be selected to show additional data regarding the selected vitals parameter. The additional data can include any one or more of historical data for that parameter, weekly trend data, graphical display of the measured parameter over time, and settings information (e.g., how often data for that parameter is gathered, what device is collecting that vital data, etc.).

The portal can include one or more communication features configured to facilitate communication between the patient and another party, e.g., between the patient and a care provider of the patient. In this illustrated example, the communication features include instant intercom 566 (e.g., answering a call request from a care provider using the mobile phone 510a), instant video 568 (e.g., answering a video chat request from a care provider using the mobile phone 510a), and a messages indicator 570 indicating whether the patient has an incoming intercom or video chat request from a care provider. Another example of a communication feature includes access to an electronic address book including contact information for members of the patient's care team. Accessing the electronic address book can allow the patient to choose a mode of communication to use for a selected member of the care team (e.g., email the care team member, call the care team member, video chat with the care team member, etc.) and/or to choose which one the care team members to contact. The electronic address book can be customized for the patient such that the patient only has access to contact information for the patient's care team. An electronic address book for another user (e.g., for a member of the care team) can include contact information for people other than members of the patient's care team. For example, the address book for a patient's care team member can include the member's colleagues, which can facilitate collaboration and/or expert access.

The portal in this illustrated example is a portal for a care provider. A portal for a care provider may differ from this illustrated portal in any of a variety of ways, such as by including access to the patient's EMR and/or by allowing switching between information for different patients.

FIGS. 22, 24, and 27 illustrate an example of a portal for the TV 510b configured to facilitate home telecare for a patient. As discussed herein, access to the portal can be limited based on security credentials. In general, the home telecare available through the TV 510b can include access to people 572 (e.g., the patient's care providers), access to care information 574 (e.g., information about the patient's medical condition and/or treatment), access to educational information 576, access to applications (apps) 578, and a call request 580 (e.g., access to emergency service, access to a care provider, etc.). Home telecare services available through the TV 510b are described further in previously mentioned U.S. application Ser. No. ______ (Attorney Docket No. SNA01 001) entitled “System And Method For Automated Deployment And Operation Of Remote Measurement And Process Control Solutions” filed on even date herewith.

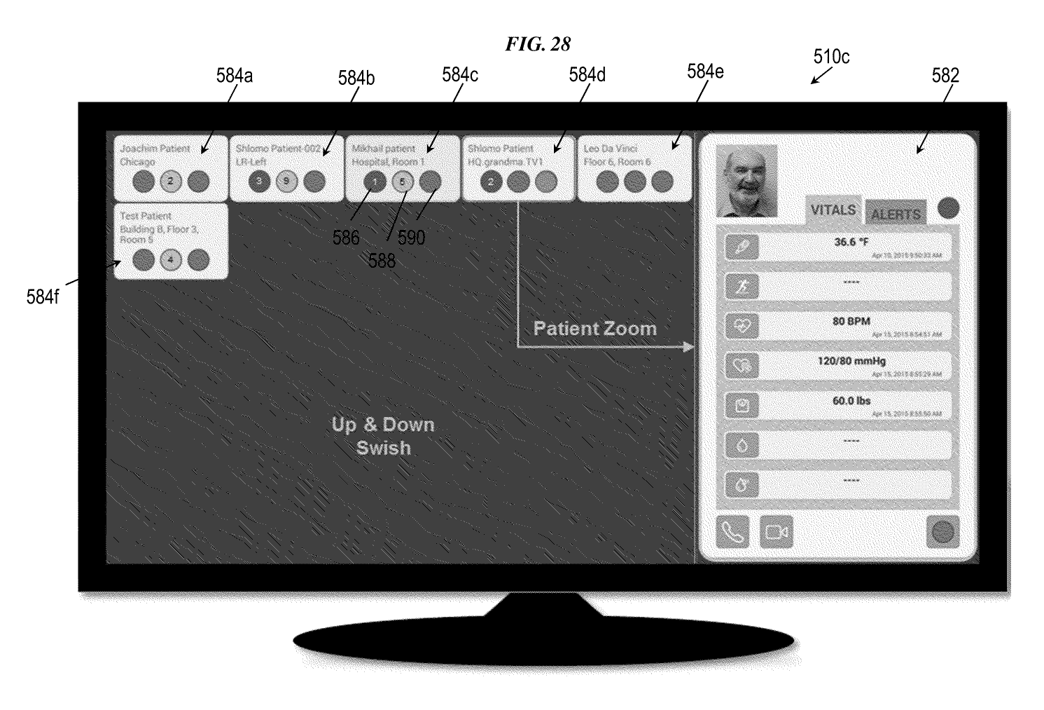

FIGS. 22, 24, and 28 illustrate an example of a portal for the touch screen 510c configured to provide patient information to care providers. Patient information can be similarly provided on other types of client terminals. As discussed herein, access to the portal can be limited based on security credentials. The care provider portal can be configured to provide vitals information for a patient similar to that discussed above regarding the mobile phone 510a. The portal of FIG. 28 includes the same vitals information display 582 as the portal of the mobile phone 510a, but vitals information can be displayed different ways to patients and care providers. In an exemplary embodiment, the care provider portal can be configured to be centrally located at a medical facility (e.g., a home care agency, a rehab nursing station, etc.) and to be accessed by any of multiple authorized care providers.

Care providers can be authorized to access information for a plurality of patients 584a, 584b, 584c, 584c, 584d, 584e, 584f, as discussed herein. For example, the care provider portal can be configured to display all patients currently checked into rooms on the hospital floor on which the computer 510c is located. For another example, the care provider portal can be configured to display all patients currently scheduled for an in-person consultation that day with the care provider. For yet another example, the care provider portal can be configured to display all patients of the care provider. A current location of each of the patients 584a, 584b, 584c, 584c, 584d, 584e, 584f can be shown on the screen, as in this illustrated example. The care provider GUI can be configured to allow the care provider associated with the GUI (e.g., the logged-in care provider) to select one of the plurality of patients and view information for the selected patient. A fourth listed one of the patients 584d is selected and has his information displayed on the screen of FIGS. 22, 24, and 28. The portal can be configured to allow the order of the patients 584a, 584b, 584c, 584c, 584d, 584e, 584f to be reorganized, such as by dragging and dropping the boxes identifying the patients 584a, 584b, 584c, 584c, 584d, 584e, 584f. Not all patients may be visible concurrently on the screen, but the screen can allow patients to be scrolled through, e.g., by using a scroll bar, by swiping a touchscreen, etc.

A variety of types of information can be available through the care provider portal for each of the patients 584a, 584b, 584c, 584c, 584d, 584e, 584f. One type of information includes vitals information, as discussed above. Other types of information includes alerts information indicating unviewed or unaddressed alerts for a patient and call request information indicating any unanswered call requests from a patient. Each of the types of information can be selectable on the care provider portal for each of the patients 584a, 584b, 584c, 584c, 584d, 584e, 584f on the care provider portal. As in this illustrated example, each of the patients 584a, 584b, 584c, 584c, 584d, 584e, 584f can have associated therewith a vitals icon 586 to access vitals information for that patient, an alerts icon 588 to access alerts information for that patient, and a call requests icon 590 to access call request information for that patient. In this illustrated example, the vitals icon 586 is accessed for the fourth patient 584d such that the fourth patient's vitals information is shown on the screen. In general, the icons 586, 588, 590 can help the care provider GUI focus staff attention on the most urgent issues. The portal can be configured to provide the patients 584a, 584b, 584c, 584c, 584d, 584e, 584f in an order of priority, e.g., based on a number of alerts for a patient, based on whether a call is requested, etc.

As in this illustrated example, each of the icons 586, 588, 590 can be configured to reflect a current status of the information with which it is associated. The care provider can thus more accurately assess which of the patients' information should be reviewed. The vitals icon 586 can indicate a number of new vitals parameter measurements for that patient (e.g., five for the third patient 584c, none for the fourth patient 584d since all vitals are currently being viewed, none for the fifth patient 584e, etc.). The vitals icon 586 can change color based on the number of new vitals parameter measurements, e.g., one color for “zero” and another color for any number “one” or greater. The alerts icon 588 can indicate a number of alerts for the patient that have not yet been viewed or addressed. The alerts icon 588 can change color based on the number of alerts, e.g., one color for “zero” and another color for any number “one” or greater. The call requests icon 590 can indicate whether or not the patient has requested a care provider but has not yet been visited by one. As in this illustrated example, a pending call request can be indicated by the icon 590 being one color and no call request pending being indicated by the icon 590 being a different color.

One skilled in the art will appreciate further features and advantages of the invention based on the above-described examples. Accordingly, the invention is not to be limited by what has been particularly shown and described, except as indicated by the appended claims. All publications and references cited herein are expressly incorporated herein by reference in their entirety.

1. A method of managing health care, comprising:
receiving at a central server sensor data from a first client terminal having a first application installed thereon, the sensor data being indicative of information gathered by at least one sensor regarding at least one parameter related to at least one of health and wellness of a patient, and the first application being configured to facilitate gathering of the information and transmission of the gathered information in real time with the gathering of the information, the sensor data received at the central server being anonymous so as to not be associated with protected health information (PHI) identifying the patient; and
causing the received sensor data to be transmitted in real time from the central server to a second client terminal having a second application installed thereon, the second application being configured to facilitate receipt of the data from the central server and display of the data on the second client terminal in real time with the receipt of the sensor data at the second client terminal.

2. The method of claim 1, further comprising analyzing the sensor data received at the central server in real time to determine if the received information indicates an alarm condition; and
in response to determining that the alarm condition is indicated, causing an alert to be transmitted in real time to the second client terminal indicating occurrence of the alarm condition.

3. The method of claim 1, wherein the transmission to the second terminal occurs automatically in response to the receipt of the sensor data at the central server.

4. The method of claim 1, wherein the transmission to the second terminal occurs in response to a request received at the central server from the second client terminal requesting data gathered by the at least one sensor.

5. The method of claim 1, further comprising receiving an electronic order for a patient, the order indicating the at least one parameter to be measured in real time with respect to the patient; and
in response to receiving the electronic order, causing the first application to be transmitted to a first client terminal, and causing the second application to be transmitted to the second client terminal.

6. The method of claim 1, further comprising causing the sensor data received at the central server to be persistently stored in a storage device, the stored sensor data not being associated with PHI information identifying the patient.

7. The method of claim 1, further comprising causing at least one of an electronic medical record (EMR) and electronic health record (EHR) of the patient to be updated in response to the receipt of the sensor data at the central server.

8. The method of claim 1, further comprising receiving at the central server user input data from the second client terminal, and causing at least one of an electronic medical record (EMR) and electronic health record (EHR) of the patient to be updated in response to the receipt of the user input data at the central server, the user input data being input to the second client terminal by a user and being related to the sensor data received at the second client terminal.

9-10. (canceled)

11. The method of claim 1, further comprising querying the first client terminal to determine a location of the at least one sensor, the location of the at least one sensor being indicative of a location of the patient.

12. The method of claim 11, further comprising querying a plurality of additional client terminals, each of the additional client terminals having associated therewith one or more sensors configured to gather information regarding at least one parameter related to at least one of health and wellness of one of a plurality of patients, to determine a location of each of the one or more sensors associated with the additional client terminals, the locations of the one or more sensors being indicative of locations of the plurality of patients.

13-16. (canceled)

17. A method of managing health care, comprising:
gathering of patient data by a first application operating as an embedded function of a first client terminal, the data being indicative of information regarding at least one parameter related to health and wellness of a patient, the gathered data not being persistently stored at the first client terminal;
transmitting the gathered patient data in real time from the first client terminal to a central server, the transmitted data being constructed as an anonymous patient data record so as to not be associated with protected health information (PHI) identifying the patient, the first application being configurable using a downloadable configuration template to facilitate the gathering of the patient data and the transmission of the gathered data in real time with the gathering of the data; and
causing the received patient data record to be transmitted from the central server to a second application operating as an embedded function of a second client terminal;
wherein the second application is configured to request and receive a patient data record from the central server, and the second application is configured to cause display of at least a portion of the requested and received patient data record on a display of the second client terminal in real time with the receipt of the requested and received patient data record.

18. The method of claim 17, wherein the second client terminal is either included as part of the first client terminal or is a client terminal independent of the first client terminal.

19-20. (canceled)

21. The method of claim 17, further comprising determining a presence of the patient by one of
with the first application, scanning for a Bluetooth low energy (BLE) sensor device used as an identifying radio frequency identification (RFID) device to establish an identification of the patient, receiving a real time user input at the first client terminal, and receiving a parameterization input via the second application as part of a downloadable configuration template as part of a care path directive associated with the patient;
causing the first application to confirm the presence and related identification of the patient with a cloud administration server, from which the first client terminal receives an anonymous and unique patient identification token used to record and identify the anonymous patient data record following the transmission of the gathered patient data to the central server; and
causing the cloud administration server to transmit to the first application, with the patient identification token, one or more templates, the one or more templates including the care path directive associated with the patient, the care path direction specifying time and method for the gathering of the patient data and including instructions regarding how to analyze and process data related to the patient and a care plan for the patient.

22-31. (canceled)

32. The method of claim 17, wherein at least one patient-wearable sensor is in communication with the first application;
the at least one patient-wearable sensor being configured to gather the patient data;
the at least one patient-wearable sensor being configured as an active radio frequency identification (RFID) sensor allowing identification of the patient at least one indirectly through a unique media access control (MAC) address thereof or directly through presentation of a system-unique patient identifier by the at least one patient-wearable sensor; and
the method further comprising the first application determining presence of the patient using the identification of the patient, thus associating a location of the patient relative to a location of the first client terminal using an open standards-based wireless association method, the location of the first client terminal being physical or logical.

33. (canceled)

34. The method of claim 17, wherein the first client terminal includes a plurality of client terminals each having an instance of the first application embedded thereon, and the method further comprises querying the first applications in real time, thereby causing the plurality of client terminals to scan for its association with one or more active radio frequency identification (RFID) sensors to determine a location of the one or more active RFID sensors relative to the associated one of the plurality of client terminals, the location of the one or more active RFID sensors being indicative of the locations of a related plurality of patients at that time relative to a location of an associated one of the client terminals, thereby establishing an overall patient census and a location map relative to physical locations of the plurality of client terminals, the location of the associated client terminals being physical or logical.

35-43. (canceled)

44. A system for managing health care, comprising:
a cloud server configured to receive data indicative of measurements of at least one parameter with respect to a patient from a client terminal without the received data being explicitly associated with protected health information (PHI) identifying the patient, the at least one parameter being related to at least one of health and wellness of the patient;
a first storage device being configured to electronically communicate with the cloud server, the cloud server being configured to cause the first storage device to store therein the data received by the cloud server without the stored data being associated with PHI identifying the patient; and
a second storage device being configured to electronically communicate with the cloud server, the cloud server being configured to cause the second storage device to store therein the data received by the cloud server with the stored data being associated with PHI identifying the patient;
wherein the cloud server is configured to distribute the received data to at least one additional client terminal without the distributed data being associated with PHI identifying the patient, and the cloud server is configured to cause at least one of an electronic medical record (EMR) and electronic health record (EHR) of the patient to be updated based on the received data.

45. The system of claim 44, further comprising at least one sensor configured to measure the at least one parameter, the at least one sensor being configured to transmit the measurements to the client terminal that then transmits the data to the cloud server.

46. The system of claim 44, wherein the cloud server is configured to receive the data in real time with gathering thereof;
the cloud sever is configured to analyze the received data in real time with the receipt thereof to determine if the received data indicates an alarm condition; and
in response to determining that the alarm condition is indicated, the cloud server is configured to transmit an alert in real time with the determination of the alarm condition to at least one of the client terminal and one or more additional client terminals, the alert indicating occurrence of the alarm condition.

47. The system of claim 44, wherein the at least one parameter includes at least one of heart rate, blood pressure, temperature, weight, oxygen saturation (spO2), electrocardiography (ECG), glucose, sleep, pulse, and motion.

48. The system of claim 44, wherein the cloud server is configured to cause the first storage device to store therein the data received by the cloud server with a secure, anonymous patient identification token that is generated by the cloud server from the PHI identifying the patient.
